(19) United States
(12) Patent Application Publication
(10) Pub. No.: US 2015/0356726 A1
(43) Pub. Date: Dec. 10, 2015

(54) INSPECTION APPARATUS, INSPECTION METHOD, EXPOSURE SYSTEM, EXPOSURE METHOD, AND DEVICE MANUFACTURING METHOD

(71) Applicant: NIKON CORPORATION, Chiyoda-ku, Tokyo (JP)

(72) Inventor: Kazuhiko FUKAZAWA, Kamakura-shi (JP)

(21) Appl. No.: 14/758,030

(22) PCT Filed: Dec. 26, 2013
(86) PCT No.: PCT/JP2013/084890

§ 371 Date: Aug. 27, 2015

(30) Foreign Application Priority Data
Dec. 27, 2012 (JP) 2012-286382

(51) Int. Cl. G06T 7/00; G06K 9/00

(52) U.S. Cl. CPC G06T 7/0008; G06T 7/004; G06K 9/00986; G06T 2207/10004; G06T 2207/10152; G06T 2207/30148

(57) ABSTRACT

In order to inspect each processing condition among a plurality of processing conditions with high accuracy using a substrate having a pattern processed under the plurality of processing conditions, an inspection apparatus is provided with: a stage which is capable of holding a wafer having a pattern formed thereon under a plurality of exposure conditions; an illumination system which illuminates the surface of the wafer with polarized light; an imaging device and an image processing section which receive light emitted from the surface of the wafer, and detect a condition for prescribing the polarization state of the light; and a computing section which determines an apparatus condition for determining the exposure condition of the pattern on the basis of the condition for prescribing the polarization state of light emitted from a condition-parameterizing wafer having a pattern formed thereon under a known exposure condition.

### CROSS REFERENCE TO RELATED APPLICATIONS

This is the National Stage of International Application No. PCT/JP2013/084890 filed on Dec. 26, 2013 which claims priority to Japanese Patent Application No. 2012-286382 filed on Dec. 27, 2012. The contents of the aforementioned applications are incorporated herein by reference in their entirety.

### BACKGROUND

The present disclosure relates to an inspection technique for determining a processing condition of a pattern formed on a substrate, and to an exposure technique using this inspection technique, and to a device manufacturing technique using this exposure technique.

In an exposure device such as a scanning stepper or a stepper used in lithography processes for manufacturing a device (a semiconductor device or the like), it is necessary to manage a plurality of exposure conditions including an exposure amount (that is, dose), a focus position (defocus amount for a substrate to be exposed with respect to the image plane of a projection optical system), and an exposure wavelength, and the like, with high accuracy. To do so, it is necessary to expose a substrate using an exposure device and to determine the actual exposure conditions of the exposure device with high accuracy using a pattern or the like formed on the exposed substrate.

For example, as a method for inspecting the focus position of an exposure device in the related art, a method is known in which a pattern for evaluation on a reticle is illuminated with illumination light of which the principal ray is inclined, a plurality of shots on a substrate are sequentially exposed to the image of the pattern while the height of the substrate is changed using a stage, the lateral shift amount of the resist pattern obtained by development after exposure is measured, and the focus position of each shot at the time of exposure is determined from the measurement result (for example, refer to US Patent Application Publication No. 2002/0100012).

### SUMMARY OF EMBODIMENTS

In the methods for inspecting a focus position in the related art, there is a concern that effects such as variations in the exposure amount and the like will also be included to some extent in the measurement results. In order to evaluate individual exposure conditions with high accuracy in the future, it is preferable to suppress the effects of other exposure conditions to the greatest extent possible.

Meanwhile, the focus position inspection method in the related art requires that exposure be performed using a dedicated evaluation pattern, and evaluation has thus been difficult in a case where a pattern for an actual device is used for exposure.

An aspect consistent with the present disclosure has been made in consideration of the above problems, and an object of the present disclosure is to determine each of a plurality of processing conditions with high accuracy using a substrate having a pattern provided by processing under the plurality of processing conditions (for example, exposure conditions).

According to a first aspect of the present disclosure, there is provided an inspection apparatus which determines a processing condition for a pattern. The apparatus includes: a stage capable of holding a substrate having a pattern formed on the surface thereof, an illumination unit which illuminates the surface of the substrate with polarized light, a detection section which receives light emitted from the surface of the substrate and detects a condition for prescribing the polarization state of the light, a storage section which stores an apparatus condition for determining the processing condition of an inspection target pattern formed on the surface of an inspection target substrate on the basis of a condition for prescribing the polarization state of light emitted from a substrate having a pattern formed thereon under the known processing condition, and an inspector which determines the processing condition of the inspection target pattern on the basis of a condition for prescribing the polarization state of light emitted from the surface of the inspection target substrate under the apparatus condition.

Furthermore, according to a second aspect, there is provided an exposure system including an exposure section having a projection optical system which exposes a surface of a substrate to a pattern, the inspection apparatus according to the first aspect, and a control section which corrects a processing condition in the exposure section according to the processing condition determined by the inspection apparatus.

Furthermore, according to a third aspect, there is provided an inspection method for determining a processing condition of an inspection target pattern. The method includes:

illuminating a surface of an inspection target substrate having an inspection target pattern formed thereon with polarized light under an inspection condition based on a condition for prescribing the polarization state of light emitted from a substrate having a pattern formed thereon under the known processing condition, receiving light emitted from the surface of the inspection target substrate under the inspection condition and detecting the condition for prescribing the polarization state of the light, and determining the processing condition of the inspection target pattern on the basis of the condition for prescribing the detected polarization state.

Furthermore, according to a fourth aspect, there is provided an exposure method including: exposing a surface of a substrate to a pattern, determining a processing condition of the substrate using the inspection method of the third aspect, and correcting the processing condition during exposure of the substrate according to the processing condition determined using the inspection method.

Furthermore, according to a fifth aspect, there is provided a device manufacturing method including a working process which provides a pattern on a surface of a substrate. The method uses the exposure method of the fourth aspect in the working process.

### Exemplary Effects of Embodiments

Consistent with the present disclosure, by using a substrate having a pattern provided by processing under a plurality of processing conditions, each of the plurality of processing conditions is evaluated with high accuracy.

### BRIEF DESCRIPTION OF DRAWINGS

FIG. 1A is a diagram illustrating an overall configuration of an inspection apparatus according to an embodiment. FIG. 1B is a plan view illustrating a wafer. FIG. 1C is a plan view illustrating a condition-parameterizing wafer.

FIG. 2A is an enlarged perspective view illustrating a non-planar structure having a repetitive pattern. FIG. 2B is a diagram illustrating a relationship between a surface on which linearly polarized light is incident and the repetitive pattern cycle direction (or repetitive direction).

FIG. 3A is a diagram illustrating an example of a relationship between an exposure amount and a change in a polarization state. FIG. 3B is a diagram illustrating an example of a relationship between a focus position and a change in the polarization state.

FIG. 4 is a flow chart illustrating an example of a method for determining an inspection condition (condition setting).

FIG. 5 is a flow chart illustrating an example of an exposure condition inspection method.

FIG. 6A is a plan view illustrating an example of a shot arrangement of a condition-parameterizing wafer 10. FIG. 6B is an enlarged view illustrating one shot. FIG. 6C is an enlarged view illustrating an example of an arrangement of a plurality of setting regions in a shot.

FIG. 7A is a diagram illustrating an example of changes in signal intensity distribution corresponding to a Stokes parameter S2 in a case where an incident angle is changed. FIG. 7B is a diagram illustrating an example of changes in luminance distribution corresponding to a Stokes parameter S3 in a case where the incident angle is changed.

FIGS. 8A and 8B each show an example of changes in sensitivity of Stokes parameters S1 to S3 with respect to changes in the exposure amount and focus position in a case where incident angle is changed.

FIGS. 9A, 9B, and 9C respectively show an example of changes in sensitivity of the Stokes parameters S1, S2, and S3 with respect to changes in the exposure amount and focus position in a case where the angle of the polarization direction of incident light is changed.

FIGS. 10A and 10B each show an example of a relationship between the Stokes parameter S2, and the exposure amount and focus value. FIGS. 10C and 10D each show an example of a relationship between the Stokes parameter S3, and the exposure amount and focus value.

FIGS. 11A and 11B show an exposure amount change curve and a focus change curve measured under different inspection conditions.

FIG. 12 is a diagram illustrating an example of a template for determining adequacy of the exposure amount.

FIG. 13A is an enlarged cross-sectional view illustrating the main section of a wafer in a second embodiment. FIG. 13B is an enlarged cross-sectional view illustrating the main section of the wafer on which a spacer layer is formed. FIG. 13C is an enlarged cross-sectional view illustrating the wafer following a process illustrated in FIG. 13B. FIG. 13D is an enlarged cross-sectional view illustrating a part of a pattern formed on the wafer. FIG. 13E is a diagram illustrating an example of changes in the Stokes parameters S2 and S3 with respect to a deposition amount of the spacer layer. FIG. 13F is a diagram illustrating an example of changes in the Stokes parameters S2 and S3 with respect to an etching amount.

FIG. 14 is a flow chart illustrating an example of a method for determining an inspection condition in the second embodiment (condition setting).

FIG. 15 is a flow chart illustrating an example of a processing condition inspection method in the second embodiment.

FIG. 16A is a diagram illustrating an inspection apparatus of a third embodiment. FIG. 16B is a schematic configuration diagram illustrating an exposure device.

FIG. 17 is a flow chart illustrating an example of a method for determining an inspection condition in the third embodiment (condition setting).

FIG. 18 is a flow chart illustrating an example of an exposure condition inspection method in the third embodiment.

FIG. 19 is a flowchart illustrating a method for manufacturing a semiconductor device.

### DESCRIPTION OF EMBODIMENTS

### First Embodiment

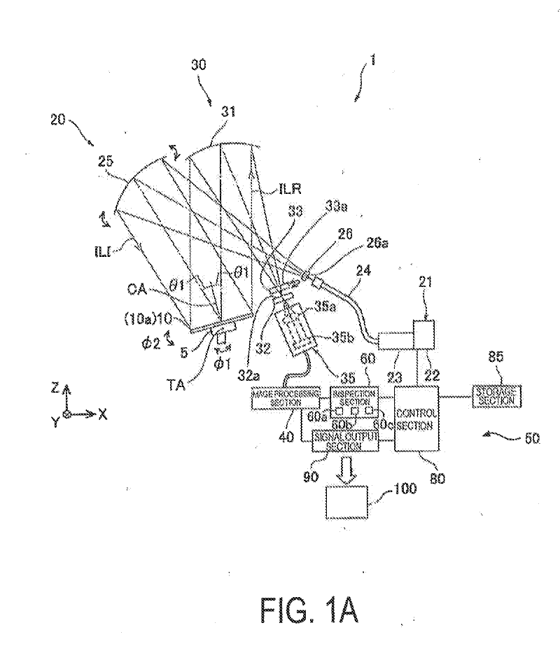

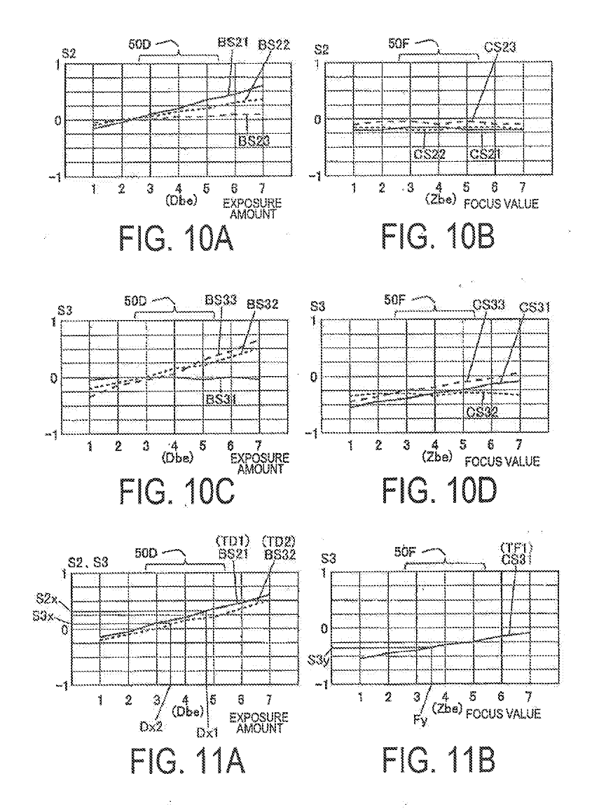

Hereinafter, a first embodiment consistent with the present disclosure will be described with reference to FIG. 11A to FIG. 11B. FIG. 1A illustrates an inspection apparatus 1 according to the present embodiment. In FIG. 1A, the inspection apparatus 1 is provided with a stage 5 which supports an approximately disk-shaped semiconductor wafer (hereinafter, simply referred to as a wafer) 10. The wafer 10, which is carried by a carrier system (not illustrated), is placed on an upper surface (a placement surface) of the stage 5, and fixed and held thereon by vacuum suction, for example. Below, description will be given in which, on a plane parallel to the upper surface of the stage 5 which is not inclined, the X axis is a direction parallel to the paper surface of FIG. 1A, the Y axis is a direction orthogonal to the paper surface of FIG. 1A, and the Z axis is a direction orthogonal to the plane including the X axis and the Y axis. Here, in FIGS. 1B and 1C to be described below, on a plane parallel to the surface of the wafer 10 or the like, two orthogonal axes are set as the X axis and Y axis, and an orthogonal axis to the plane including the X axis and the Y axis is set as the Z axis. In FIG. 1A, the stage 5 is supported on a base member (not illustrated) via a first driving section (not illustrated) which controls a rotation angle Φ1 around a normal line CA in the center of the upper surface of the stage 5, and a second driving section (not illustrated) which controls a tilt angle Φ2 (tilt angle of the surface of the wafer 10) which is, for example, an inclination angle around an axis TA (tilt axis parallel to the Y axis in FIG. 1A) passing through the center of the upper surface of the stage 5 and orthogonal to the paper surface of FIG. 1A.

The inspection apparatus 1 is further provided with an illumination system 20 which irradiates, with illumination light ILI as collimated light, the surface (hereinafter, referred to as the wafer surface) of the wafer 10 which is supported on the stage 5 and which has a predetermined repetitive pattern formed thereon, a light-receiving system 30 which condenses light (specularly reflected light, diffracted light, or the like) emitted from the wafer surface upon being irradiated with the illumination light ILI, an imaging device 35 which receives light condensed by the light-receiving system 30 and detects an image of the wafer surface, an image processing section 40 which determines a condition for prescribing the polarization state by processing an image signal output from the imaging device 35, and a computing section 50 which performs determination of an exposure condition (processing condition) of the pattern on the wafer surface using the condition information, or the like. The imaging device 35 has an image forming lens 35a which forms an image of the wafer surface, and a two-dimensional imaging element 35b such as, for example, a charge coupled device (CCD) or a complementary metal oxide semiconductor (CMOS), and the imaging element 35b images the entire surface of the wafer at once and outputs the image signal.

The image processing section 40 generates information (signal intensity for each pixel, averaged signal intensity for every shot, averaged signal intensity for every region smaller than a shot, and the like) about a digital image of the wafer 10 on the basis of the image signal of the wafer 10 input from the imaging device 35, and outputs, to the computing section 50, Stokes parameters to be described below as a condition for prescribing the polarization state obtained on the basis of this information. The condition for prescribing the polarization state include a first prescribing condition and a second prescribing condition as an example, and, for instance, the first prescribing condition is the Stokes parameter S2 to be described below and the second prescribing condition is the Stokes parameter S3 to be described below. Here, the image processing section 40 is also configured so as to be capable of simply outputting, to the computing section 50, information (information about the signal intensity distribution for every pixel, or the like) about a digital image. Furthermore, the computing section 50 is provided with an inspection section 60 including computing sections 60a, 60b, and 60c which process information such as the Stokes parameters, a control section 80 which controls the operations of the image processing section 40 and the inspection section 60 or the like, a storage section 85 which stores information relating to an image or the like, and a signal output section 90 which outputs the obtained exposure condition inspection result (to be described below) to a control section (not illustrated) of an exposure device 100.

The illumination system 20 has an illumination unit 21 which emits illumination light and an illumination-side concave mirror 25 which reflects the illumination light emitted from the illumination unit 21 toward the wafer surface as collimated light. The illumination unit 21 has a light source 22 such as a metal halide lamp or a mercury lamp, a light adjustment section 23 which selects light of a predetermined wavelength (for example, different wavelengths λ1, λ2, λ3, and the like) out of light from the light source 22 according to a command from the control section 80 and adjusts the intensity of the light, a light guiding fiber 24 which emits light selected and adjusted in intensity by the light adjustment section 23 from a predetermined emission surface to the illumination-side concave mirror 25, and a polarizer 26 which linearly polarizes illumination light emitted from the emission surface of the light guiding fiber 24. The polarizer 26 is, for example, a polarizing plate having a transmission axis, and is rotatable around an axis that passes through the center of an incident surface 26a on which illumination light emitted from the emission surface of the light guiding fiber 24 is incident and that is orthogonal to the incident surface 26a. That is, it is possible to set the orientation of the transmission axis of the polarizer 26 to a desired orientation, and thus it is possible to set the polarization direction (that is, the oscillation direction of the linearly polarized light) of the linearly polarized light which is incident on the wafer surface via the polarizer 26 to a desired direction. The rotation angle of the polarizer 26 (that is, the orientation of the transmission axis of the polarizer 26) is controlled by a driving section (not illustrated) on the basis of a command from the control section 80. Furthermore, as an example, the wavelength λ1 is 248 nm, λ2 is 265 nm, and λ3 is 313 nm. In such a case, since the emission surface of the light guiding fiber 24 is arranged on the focal plane of the illumination-side concave mirror 25, the illumination light ILI reflected by the illumination-side concave mirror 25 illuminates the wafer surface as a collimated light flux. It is possible to adjust an incident angle θ1 of the illumination light with respect to the wafer 10 by controlling the position of the emission section of the light guiding fiber 24 and the position and angle of the illumination-side concave mirror 25 through a driving mechanism (not illustrated) according to a command from the control section 80. The position and angle of the illumination-side concave mirror 25 in the present embodiment is controlled by the illumination-side concave mirror 25 being tilted around the tilt axis TA of the stage 5, thereby adjusting the incident angle θ1 of the illumination light which is incident on the wafer surface. In the present embodiment, the tilt angle Φ2 of the stage 5 is controlled such that specularly reflected light (light at an emission angle Φ1 from the wafer surface) ILR from the surface of the wafer 10 is incident on the light-receiving system 30. Here, the incident angle θ1 of the illumination light with respect to the wafer surface is an angle formed by the normal line CA of the stage 5 and the principal ray which is incident on the wafer surface, and the emission angle Φ2 from the wafer 10 is an angle formed by the normal line CA of the stage 5 and the principal ray emitted from the wafer surface.

As a result, in a state where the polarizer 26 is inserted in the optical path, inspection using linearly polarized light is performed. Here, in a state where the polarizer 26 is removed from the optical path or a state where the polarizer 26 is in the optical path, it is also possible to perform inspection using diffracted light other than the specularly reflected light from the wafer 10.

The light-receiving system 30 has a light-receiving-side concave mirror 31 arranged to face the stage 5, a quarter-wavelength plate 33 arranged in the optical path of the light reflected by the light-receiving-side concave mirror 31, and an analyzer 32 arranged in the optical path of the light passing through the quarter-wavelength plate 33, and an imaging surface of the imaging element 35b of the imaging device 35 is arranged on the focal plane of the light-receiving-side concave mirror 31. For this reason, collimated light emitted from the wafer surface is condensed by the light-receiving-side concave mirror 31 and the image forming lens 35a of the imaging device 35, and an image of the wafer 10 is formed on an imaging surface of the imaging element 35b in the imaging device 35. The analyzer 32 is, for example, a polarizing plate having a transmission axis in the same manner as the polarizer 26, and is rotatable around an axis that passes through the center of an incident surface 32a on which light reflected by the light-receiving-side concave mirror 31 is incident and that is orthogonal to the incident surface 32a. That is, it is possible to set the orientation of the transmission axis of the analyzer 32 to a desired orientation, and thus it is possible to set the oscillation direction of the linearly polarized light to be converted by the analyzer 32 to a desired direction. The rotation angle (orientation of the transmission axis of the polarizing plate) of the analyzer 32 is controlled by a driving section (not illustrated) on the basis of a command from the control section 80. As an example, it is possible to set the transmission axis of the analyzer 32 to a direction (crossed Nicols) orthogonal to the transmission axis of the polarizer 26. Furthermore, the quarter-wavelength plate 33 is rotatable around an axis that passes through the center of an incident surface 33a on which light reflected by the light-receiving-side concave mirror 31 is incident and that is orthogonal to the incident surface 33a. It is possible to control the rotation angle of the quarter-wavelength plate 33 in a range of 360° using a driving section (not illustrated) on the basis of a command from the control section 80. A plurality of images of the wafer 10 obtained while rotating the quarter-wavelength plate 33 are processed, which makes it possible to determine the Stokes parameters that are conditions for prescribing the polarization state of the light reflected from the wafer 10, for example, for every pixel, as will be described below.

Furthermore, the wafer 10 has a resist (for example, a photosensitive resin) on the uppermost layer thereof projection-exposed to a predetermined pattern via a reticle using the exposure device 100, and is carried onto the stage of the inspection apparatus 1 after being subjected to development using a coater/developer (not illustrated). Here, a repetitive pattern 12 (refer to FIG. 1B) is formed on the upper surface of the wafer 10 carried onto the stage 5 through steps of exposure and development using the exposure device 100 and the coater/developer (not illustrated). At this time, the wafer 10 is carried onto the stage 5 having undergone alignment by an alignment mechanism (not illustrated) during the carrying process, using a pattern within the shots on the wafer 10, a mark on the wafer surface (a search-alignment mark, for example), or an outer edge portion (a notch, an orientation flat, or the like) as a reference. As illustrated in FIG. 1B, a plurality of shots (shot regions) 11 are arranged on the wafer surface at predetermined intervals in two orthogonal directions (assumed to be an X direction and a Y direction), and the non-planar repetitive pattern 12, such as a line pattern, a hole pattern, or the like, is formed in each of the shots 11 as a semiconductor device circuit pattern. Here, in FIGS. 1B and 1C, the two orthogonal axes on a plane parallel to the surfaces of the wafers 10 and 10a are set as the X axis and the Y axis, and the axis perpendicular to the plane including the X axis and the Y axis is set as the Z axis. The repetitive pattern 12 may, for example, be a pattern made from a dielectric such as a resist pattern, or may be a pattern made from a metal. Although a single shot 11 often includes a plurality of chip regions, it should be noted that FIG. 1B illustrates a single chip region in a single shot in order to facilitate understanding.

After the image of the wafer surface is processed according to a command from the control section 80 as described below, the inspection section 60 determines a predetermined exposure condition out of a plurality of exposure conditions including the exposure amount (in other words, dose) of the exposure device 100 which exposes the wafer 10, the focus position (the position of the image plane of the reticle pattern in the optical axis direction of the projection optical system in the exposure device, the defocus amount of the image plane of the reticle pattern in the optical axis direction of the projection optical system with respect to the wafer to be exposed, or the like), the exposure wavelength (the center wavelength and/or the half value width), and the temperature of the liquid between the projection optical system and the wafer in a case of exposure using a liquid immersion method. The exposure condition determination result is supplied to a control section (not illustrated) in the exposure device 100, and thus it is possible for the exposure device 100 to correct the exposure condition (for example, correction of offset, variations, and the like) according to the inspection result. Here, the exposure condition is an example of the processing condition of the repetitive pattern formed on the wafer, and, the exposure condition as an example includes the first exposure condition as the first processing condition and the second exposure condition as the second processing condition. As an example, the first exposure condition is the exposure amount, and the second exposure condition is the focus position.

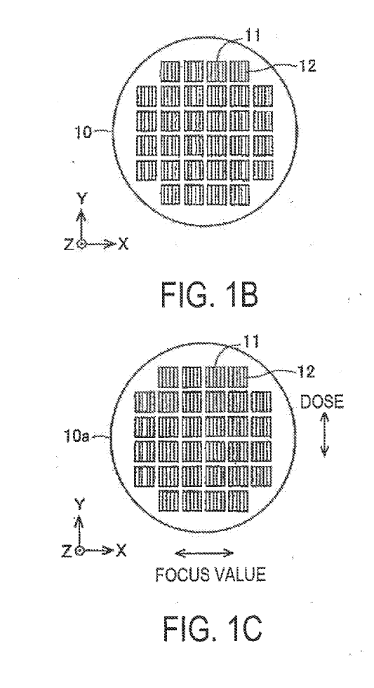

Description will be given of an example of a method for performing inspection on the basis of a change in the polarization state of the light reflected from the wafer surface using the inspection apparatus 1 configured as described above. In such a case, as illustrated in FIG. 2A, the repetitive pattern 12 on the wafer surface in FIG. 1B is a resist pattern (for example, a line pattern) in which a plurality of line sections 2A are arranged at a constant pitch (that is, a cycle) P to interpose space sections 2B along the arrangement direction (here, the X direction) which is the transverse direction of the line sections 2A. The arrangement direction (the X direction) of the line sections 2A is also called the cycle direction (or repetitive direction) of the repetitive pattern 12.

Here, the design value of a line width D_{A} of the line sections 2A in the repetitive pattern 12 is set as half of the pitch P. In a case where the repetitive pattern 12 is formed under the appropriate exposure condition (that is, the exposure amount and the focus position), the line width D_{A} of the line sections 2A and a line width D_{B} of the space sections 2B are set to be equal, side walls 2Aa of the line sections 2A are formed at an approximately right angle with respect to the surface of the wafer 10, and the volume ratio between the line sections 2A and the space sections 2B is approximately 1:1. Furthermore, at this time, the shape of the X-Z cross section of the line sections 2A is square or rectangular. In contrast, when the focus position in the exposure device 100 deviates from the appropriate focus position when forming the repetitive pattern 12, the pitch P does not change; however, the side walls 2Aa of the line sections 2A are not at right angles with respect to the surface of the wafer 10, and the shape of the X-Z cross section of the line sections 2A is trapezoidal. Accordingly, the side walls 2Aa of the line sections 2A and the line widths D_{A} and D_{B} of the line sections 2A and the space sections 2B are different from design values, causing the volume ratio between the line sections 2A and the space sections 2B to deviate from approximately 1:1. On the other hand, when the exposure amount in the exposure device 100 changes, the pitch P and the line width D_{A} change, causing the volume ratio between the line sections 2A and the space sections 2B to deviate from approximately 1:1.

In the inspection of the present embodiment, the state (whether defective or non-defective, and the like) of the repetitive pattern 12 is inspected using changes in the polarization state of the light reflected from the wafer surface in accordance with changes in the volume ratio between the line sections 2A and the space sections 2B in the repetitive pattern 12 as described above (in other words, changes in the polarization state of the reflected light due to structural birefringence in the repetitive pattern 12 on the wafer surface). To simplify the description, an ideal volume ratio (design value) is assumed to be 1:1. Changes in the volume ratio are caused by shifts from an appropriate value of the focus position and the like, and appear in each shot 11 of the wafer 10 and furthermore in each of a plurality of regions within the shot 11. Note that volume ratio can also be rephrased as an area ratio of cross-sectional shape.

In order to inspect the pattern on the wafer surface using the inspection apparatus 1 of the present embodiment, the control section 80 reads out recipe information (inspection conditions, procedures, and the like) stored in the storage section 85, and performs the following processing. In the present embodiment, Stokes parameters S0, S1, S2, and S3 defined by the following formulas (formulas 1 to 4) of light specularly reflected by the wafer surface are measured as a condition for prescribing the polarization state. Here, axes which are orthogonal to each other in a plane perpendicular to the optical axis of the light are the x axis and the y axis, the intensity of a linearly polarized light component (horizontally polarized light) in the x direction is Ix, the intensity of a linearly polarized light component (vertically polarized light) in the y direction is Iy, the intensity of a linearly polarized light component (45° polarized light) in the direction inclined 45° with respect to the x axis is Ipx, the intensity of a linearly polarized light component (135° polarized light) in the direction inclined 135° (−45°) with respect to the x axis is Imx, the intensity of a clockwise circularly polarized light component is Ir, and the intensity of a counterclockwise circularly polarized light component is Il.

S0=total intensity of a light flux [Formula 1]

S1 (intensity difference between horizontally polarized light and vertically polarized light)=Ix−Iy [Formula 2]

S2 (intensity difference between 45° polarized light and 135° polarized light)=Ipx−Imx [Formula 3]

S3 (intensity difference between clockwise and counterclockwise circularly polarized light components)=Ir−Il [Formula 4]

Furthermore, the Stokes parameter S0 is normalized to be 1 below. In such a case, the values of the other parameters S1 to S3 are in the range of −1 to +1. The Stokes parameters (S0, S1, S2, and S3) are, for example, (1, 0, −1, and 0) in completely 135° polarized light and (1, 0, 0, and 1) in completely clockwise circularly polarized light.

First, the wafer 10 on which the inspection target repetitive pattern 12 is formed is placed at a predetermined position in a predetermined direction on the stage 5. The tilt angle of the stage 5 is set so that the light-receiving system can receive the specularly reflected light ILR from the wafer 10, that is, the reflection angle (the light receiving angle or the emission angle) of the light received by the light-receiving system 30 with respect to the wafer surface is set to be equal to the incident angle 81 of the incident illumination light ILI. In addition, as an example, the angle of the polarizer 26 is set so that the illumination light ILI incident on the wafer surface is P polarized light which is linearly polarized in a direction parallel to the incident surface. Furthermore, the rotation angle of the stage 5 is set so that, for example, the cycle direction of the repetitive pattern 12 on the wafer surface is inclined 45° to the oscillation direction of the illumination light (set as linearly polarized light L of the P polarized light in FIG. 2B) on the wafer surface as illustrated in FIG. 2B. This is to obtain the highest signal intensity of the light reflected from the repetitive pattern 12. Furthermore, the angle between the cycle direction and the oscillation direction may be changed in a case where the detection sensitivity (that is, changes in a detection signal or parameter with respect to a change in the exposure condition) is increased by setting the angle to 22.5° or 67.5°. The angle is not limited to these angles, and can be set to any desired angle.

At this time, since the illumination light incident on the wafer surface is P polarized light, as illustrated in FIG. 2B, when the cycle direction of the repetitive pattern 12 is set to a 45° angle to the incident surface of the light L (that is, the traveling direction of the light L on the wafer surface), the angle formed by the oscillation direction of the light L on the wafer surface and the cycle direction of the repetitive pattern 12 is also set to 45°. In other words, the linearly polarized light L is incident as if obliquely traveling across the repetitive pattern 12 with the oscillation direction of the light L on the wafer surface inclined 45° to the cycle direction of the repetitive pattern 12.

The specularly reflected light ILR which is collimated light reflected by the wafer surface reaches the imaging surface of the imaging device 35 via the quarter-wavelength plate 33 and the analyzer 32 after being condensed by the light-receiving-side concave mirror 31 of the light-receiving system 30. At this time, the polarization state of the specularly reflected light ILR is changed to, for example, elliptically polarized light with respect to the linearly polarized light of the incident light due to the structural birefringence in the repetitive pattern 12. The orientation of the transmission axis of the analyzer 32 is set so as to be orthogonal (to a crossed Nicols state) to the transmission axis of the polarizer 26 as an example. Accordingly, a polarized light component in which the oscillation direction is approximately at a right angle to the light L is extracted by the analyzer 32 from the specularly reflected light in which the polarization state has been changed from the wafer surface, and guided to the imaging device 35. As a result, an image of the wafer surface with the polarized light component extracted by the analyzer 32 is formed on the imaging surface of the imaging device 35. Here, it is also possible to image the wafer surface by shifting the angle of the analyzer 32 by a predetermined angle from the crossed Nicols state.

Furthermore, in the present embodiment, the Stokes parameters S0 to S3 indicating the polarization state of the light reflected from the wafer surface are determined using the rotating-retarder polarimetry as an example. In such a case, the rotation angle θ of the quarter-wavelength plate 33 is set to a plurality of angles (for example, at least four different angles) θi (i=1, 2, . . . ) in stages, the wafer surface is imaged at each of the rotation angles by the imaging element 35b, and the obtained image signals are supplied to the image processing section 40. Information relating to the rotation angle of the quarter-wavelength plate 33 is also supplied to the image processing section 40. At this time, when the zero order coefficient is a0/2, the coefficient of sin 2θ is b2, the coefficient of cos 4θ is a4, and the coefficient of sin 4θ is b4 when Fourier transform is performed on the Stokes parameter S0 (total intensity for each pixel) with respect to the rotation angle θ of the quarter-wavelength plate 33, the Stokes parameters S1, S2, and S3 correspond to the coefficients a4, b4, and b2, respectively, and thus it is possible to determine the Stokes parameters S0 to S3 in the image processing section 40.

Note that the rotating-retarder polarimetry is, for example, described in Non-Patent Literature (Tadao Tsuruta, “Ouyou Kougaku 2 (Ouyou Butsurigaku Sensho)”, page: 233, Baifukan, 1990) as a “method using a rotation A/4 plate”. Furthermore, since a detailed method for calculating the Stokes parameters is also described in Japanese Unexamined Patent Application Publication No. 2010-249627A by the present applicant, the calculation method is omitted.

In the image processing section 40, the determined information about the Stokes parameters for every pixel of the imaging device 35 is outputted to the inspection section 60. The inspection section 60 uses this information to determine the exposure condition and the like in the exposure device 100 used when forming the repetitive pattern 12 of the wafer 10. In this manner, when determining the Stokes parameters for every pixel of the image of the wafer surface, a combination of the incident angle θ1 of the illumination light ILI with respect to the wafer surface in the inspection apparatus 1 (or the emission angle θ2 of the light emitted from the wafer surface), the wavelength λ (λ1 to λ3 and the like) of the illumination light ILI, the rotation angle of the analyzer 32 (that is, the orientation of the transmission axis of the analyzer 32), the rotation angle of the polarizer 26 (that is, the orientation of the transmission axis of the polarizer 26), the rotation angle of the stage 5 (that is, the orientation of the wafer 10), and the like is referred to as one apparatus condition. It is also possible to refer to the apparatus condition as an inspection condition. In a case where inspection is performed on the basis of a change in the polarization state in this manner, it is also possible to refer to the apparatus condition as a polarization condition. A plurality of apparatus conditions are included in the recipe information of the inspection apparatus 1 stored in the storage section 85 described above. In the present embodiment, an apparatus condition suitable for determining the exposure condition of a pattern formed on the wafer is selected from the plurality of apparatus conditions. Here, the wavelength λ of the illumination light ILI, the incident angle θ1 of the illumination light ILI with respect to the wafer surface, and the rotation angle of the polarizer 26 constitute an example of an illumination condition included in the apparatus condition of the inspection apparatus 1. The emission angle of the light emitted from the wafer surface (that is, the light receiving angle of the light-receiving system 30) and the rotation angle of the analyzer 32 constitute an example of a detection condition of the detection section included in the apparatus condition of the inspection apparatus 1. The rotation angle of the stage 5 and the tilt angle Φ2 of the stage 5 (that is, the tilt angle of the wafer surface) constitute an example of a posture condition for the stage included in the apparatus condition of the inspection apparatus 1.

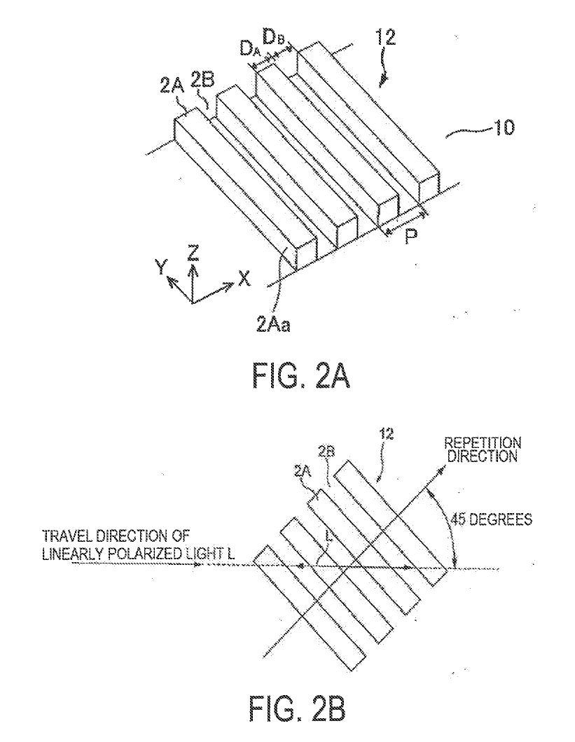

As an example, the exposure condition of the inspection target of the exposure device 100 includes the exposure amount and the focus position. In such a case, at the time of the linearly polarized light flux being incident on the wafer surface, if the pitch and the line width of the pattern change due to the exposure amount during exposure of the pattern formed on the wafer surface changing from an exposure amount D1 (under-dose) less than an appropriate amount through an optimum exposure amount D5 (best dose Dbe) to an exposure amount D8 (over-dose) greater than the appropriate amount, the polarization state of the light from reflected the wafer surface changes qualitatively in both the direction of the long axis of the elliptically polarized light (that is, inclination of the long axis of the elliptically polarized light) and the ellipticity (that is, the ratio between the length of the short axis and the length of the long axis of the elliptically polarized light) as illustrated in FIG. 3A. Furthermore, since the direction of the long axis of the elliptically polarized light corresponds to the Stokes parameter S2 and the ellipticity corresponds to the Stokes parameters S1 and S3, the Stokes parameters S1, S2, and S3 of the reflected light change as the exposure amount changes.

On the other hand, when the linearly polarized light flux is incident on the wafer surface, if the cross-sectional shape of the pattern (that is, the shape of the X-Z cross-section in FIG. 2A) changes between a rectangle (or a square) and a trapezoid due to the focus position during exposure of the pattern changing from a focus position F1 (under-focus) lower than a range of appropriate positions through an optimum focus position F4 (best focus position Zbe) to a focus position F8 (over-focus) higher than the range of appropriate positions, in regard to the polarization state of the light reflected from the wafer surface, there is a tendency for the direction of the long axis of the elliptically polarized light to be qualitatively approximately the same and for only the ellipticity to change, as illustrated in FIG. 3B. For this reason, when the focus position changes, there is a tendency for the Stokes parameters S1 and S3 of the reflected light to change comparatively greatly, and for the Stokes parameter S2 to hardly change. As a result, using the fact that the Stokes parameters which change depending on the exposure condition are different, it is possible to evaluate separate exposure conditions from the measured values of the Stokes parameters.

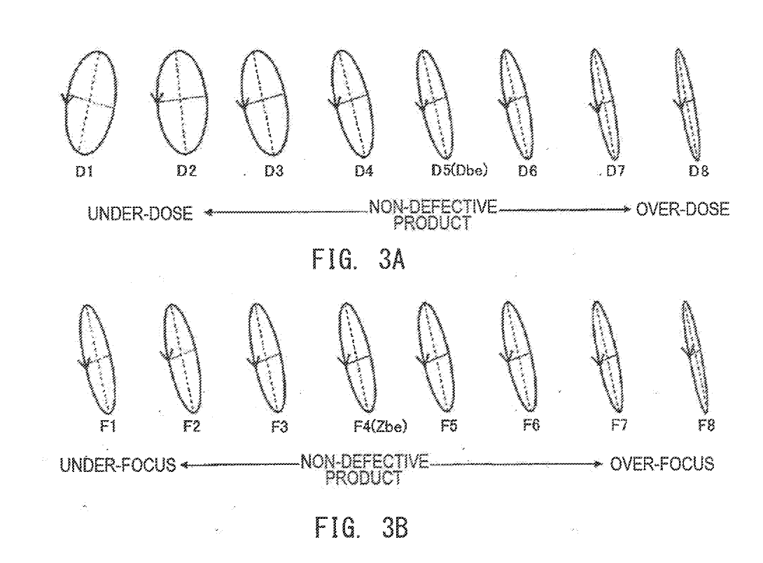

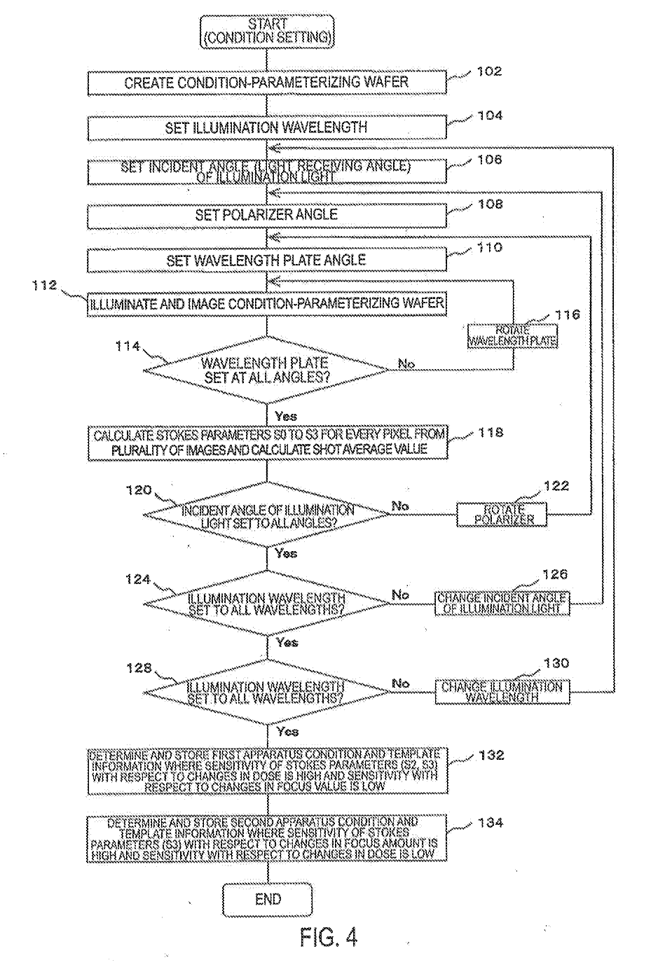

Next, in the present embodiment, description will be given with reference to the flow chart in FIG. 5 regarding an example of a method for determining the exposure condition (here, the exposure amount and the focus position) of the exposure device 100 used when forming the pattern by detecting light from the repetitive pattern on the wafer surface using the inspection apparatus 1. Furthermore, since it is necessary to determine an apparatus condition (inspection condition) in advance for carrying out the determination, description will be given of an example of a method for determining the apparatus condition (hereinafter, referred to as condition setting) with reference to the flow chart in FIG. 4. These operations are controlled by the control section 80.

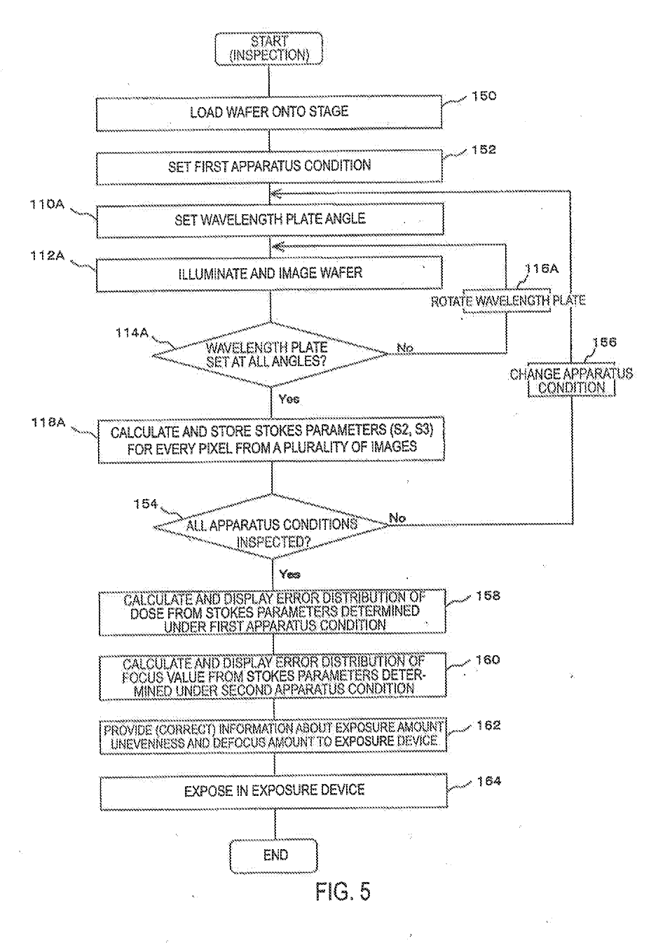

First, for condition setting, a wafer 10a illustrated in FIG. 1C is prepared in step 102 in FIG. 4. In practice, as illustrated in FIG. 6A, on the surface of the wafer 10a, N (N is, for example, an integer of approximately several tens to one hundred) shots SAn (n=1 to N) are arranged to interpose scribe line regions SL (regions which are boundaries when cutting into chips in a device dicing process) as an example. Then, the wafer 10a having a resist applied thereon is carried to the exposure device 100 in FIG. 1A, and each of the shots SAn is exposed to the same pattern of a reticle (not illustrated) for a device which is will be an actual product while changing the exposure condition such that the exposure amount is gradually changed between the shots arranged in the scanning direction (the longitudinal direction of the shots in FIG. 1C, in other words, the direction along the Y axis) and the focus position is gradually changed between the shots arranged in the non-scanning direction (the short side direction of the shots in FIG. 1C, in other words, the direction along the X axis) which is orthogonal to the scanning direction by the exposure device 100. Thereafter, the exposed wafer 10a is developed so as to produce a wafer (hereinafter, referred to as a condition-parameterizing wafer) 10a on which the repetitive pattern 12 is formed under exposure conditions which are different for each of the shots SAn.

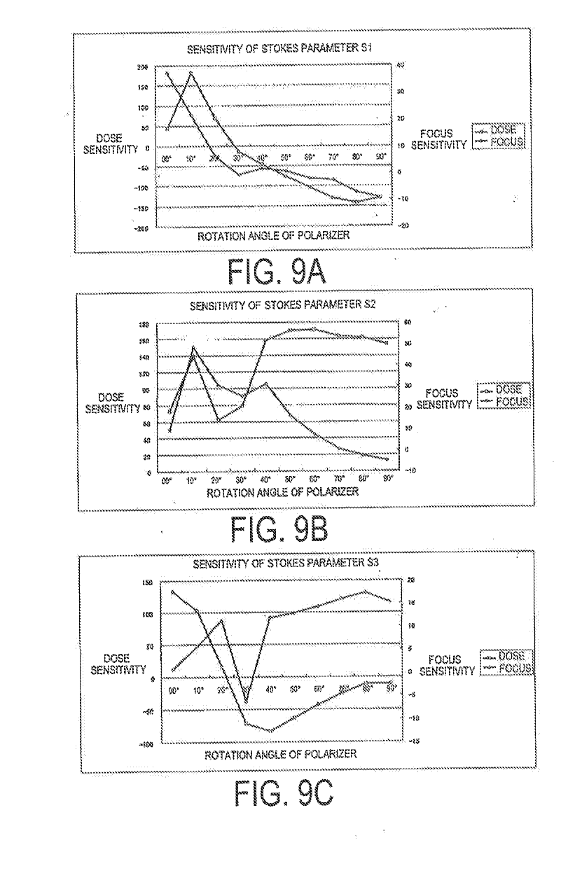

Below, a defocus amount (here, referred to as the focus value) with respect to the optimum focus position Zbe is used as a focus position. With regard to the focus position, as an example, the focus value is set in seven stages from −60 nm through 0 nm to +60 nm at 20 nm intervals. The numbers 1 to 7 of the focus values of the horizontal axis in FIG. 10B and the like to be described below correspond to the focus values (−60 to +60 nm) of the seven stages. Furthermore, as an example, the range of appropriate focus values (for example, focus values where manufactured devices do not malfunction) including the optimum focus position ZBe (focus value is 0) is represented as an appropriate range 50F. Here, it is also possible to set the focus values in a plurality of stages at, for example, 30 nm or 50 nm intervals, and it is also possible to set the focus values in 17 stages or the like from −200 nm to +200 nm at, for example, 25 nm intervals.

Then, the exposure amount is set in nine stages (10.0 mJ, 11.5 mJ, 13.0 mJ, 14.5 mJ, 16.0 mJ, 17.5 mJ, 19.0 mJ, 20.5 mJ, 22.0 mJ) at 1.5 mJ intervals centering on the optimum exposure amount Dbe. Here, for convenience of explanation, below, the exposure amount is set in seven stages and the numbers 1 to 7 of the exposure amount of the horizontal axis in FIG. 10A and the like to be described below correspond to the exposure amount of the seven stages. In addition, as an example, the range of appropriate exposure amount (for example, exposure amount where manufactured devices do not malfunction) including the optimum exposure amount DBe is represented as an appropriate range 50D.

The condition-parameterizing wafer 10a of the present embodiment is a so-called Focus Exposure Matrix wafer (FEM wafer) exposed and developed by varying the exposure amount and the focus position in a matrix form. Here, a plurality of the condition-parameterizing wafers 10a may be produced in a case where the number of shots different in a combination of exposure conditions obtained by the product of the number of stages of the focus values and the number of stages of the exposure amounts is greater than the number of shots on the entire surface of the condition-parameterizing wafer 10a.

In contrast, in a case where the number of the shots SAn arranged in the non-scanning direction is greater than the number of stages of changes in the focus value, and/or a case where the number of the shots SAn arranged in the scanning direction is greater than the number of stages of changes in the exposure amount, a plurality of shots having the same focus value and exposure amount may be formed, and the measured values obtained in relation to the shots having the same focus value and exposure amount may be averaged. In addition, for example, in order to reduce the effects of uneven application of the resist between the center portion and the peripheral portion of the wafer and the effects of differences in the scanning direction (the +Y direction or the −Y direction in FIG. 2B) of the wafer during scanning and exposure, and the like, a plurality of shots having different focus values and exposure amounts may be randomly arranged.

When the condition-parameterizing wafer 10a is produced, the condition-parameterizing wafer 10a is carried onto the stage 5 of the inspection apparatus 1. Then, the control section 80 reads out a plurality of apparatus conditions from the recipe information stored in the storage section 85. As an example, it is assumed that the wavelength λ of the illumination light ILI is any one of λ1, λ2, and λ3 described above, the incident angle θ1 of the illumination light ILI is any one of 15°, 30°, 45°, and 60°, and the rotation angle of the polarizer 26 is set to a plurality of angles at intervals of, for example, approximately 5° centering on a crossed Nicols state in the plurality of apparatus conditions. Here, it is also possible to represent the apparatus conditions in which the wavelength λ is λn (n=1 to 3), the incident angle θ1 is αm (m=1 to 4), and the rotation angle of the polarizer 26 is βj (j=1 to J, J is an integer of two or more) as the conditions ∈ (n−m−j). Here, in practice, the incident angle θ1 may be set at intervals of approximately 5° so as to be any one of 15°, 20°, 25°, 30°, 35°, 40°, 45°, 50°, 55°, and 60°.

Then, in the inspection apparatus 1, the wavelength of the illumination light ILI is set to λ1 (step 104), the incident angle θ1 is set to al (together with setting the tilt angle of the stage 5 and setting the light receiving angle of the light-receiving system 30) (step 106), the rotation angle of the polarizer 26 is set to β1 (step 108), and the rotation angle of the quarter-wavelength plate 33 is set to the initial value (step 110). Then, under these apparatus conditions, the surface of the condition-parameterizing wafer 10a is irradiated with the illumination light ILI, and the imaging device 35 images the condition-parameterizing wafer 10a and outputs the image signal to the image processing section 40 (step 112). Next, it is determined whether or not the quarter-wavelength plate 33 has been set to all of the angles (step 114). In a case of not having been set to all of the angles, the quarter-wavelength plate 33 is rotated by, for example, approximately 1.41° (that is, an angle found by dividing the angle range of 360° in which the quarter-wavelength plate 33 is rotatable by 256) (step 116), and then the flow returns to step 112 and the condition-parameterizing wafer 10a is imaged. Repeating step 112 until the quarter-wavelength plate 33 in step 114 has been rotated 360° results in 256 wafer images corresponding to the different rotation angles of the quarter-wavelength plate 33 being captured.

Thereafter, the flow proceeds from step 114 to step 118, the image processing section 40 determines the Stokes parameters S0 to S3 for every pixel of the imaging element 35b from the obtained 256 (alternatively, at least four) digital images of the wafer using the rotating-retarder polarimetry described above (step 118). The Stokes parameters S0 to S3 are outputted to a first computing section 60a of the inspection section 60, and, as an example, the average values of the Stokes parameters for every shot (hereinafter, referred to as shot average values) are determined in the first computing section 60a and outputted to the second computing section 60b and the storage section 85.

Thereafter, it is determined whether or not the rotation angle of the polarizer 26 has been set to all of the angles (step 120). In a case of not having been set to all of the angles, the polarizer 26 is rotated, for example, 5° (or −5°) and set to an angle β2 (step 122), and the flow returns to step 110. Then, the calculation of the Stokes parameters and the like are performed (steps 110 to 118) for every pixel of the image of the wafer surface using the rotating-retarder polarimetry. Thereafter, in a case where the rotation angle of the polarizer 26 has been set to all of the angles βj (j (j=1 to J), the flow proceeds from step 120 to step 124, and then it is determined whether or not the incident angle θ1 of the illumination light ILI has been set to all of the angles. In a case of not having been set to all of the angles, the incident angle θ1 is set to α2 by driving the illumination system 20 and the stage 5 (step 126), and the flow returns to step 108. Then, the calculation of the Stokes parameters and the like are performed (steps 108 to 120) for every pixel of the image of the wafer surface using the rotating-retarder polarimetry. Thereafter, in a case where the incident angle θ1 has been set to all of the angles αm (m=1 to 4), the flow proceeds from step 124 to step 128, and then it is determined whether or not the wavelength λ of the illumination light ILI has been set to all of the wavelengths. In a case of not having been set to all of the wavelengths, the wavelength λ is changed to λ2 by the illumination unit 21 (step 130), and the flow returns to step 106. Then, the calculation of the Stokes parameters and the like are performed (steps 106 to 124) for every pixel of the image of the wafer surface using the rotating-retarder polarimetry. Thereafter, in a case where the wavelength λ has been set to all of the wavelengths λn (n=1 to 3), the flow proceeds from step 128 to step 132.

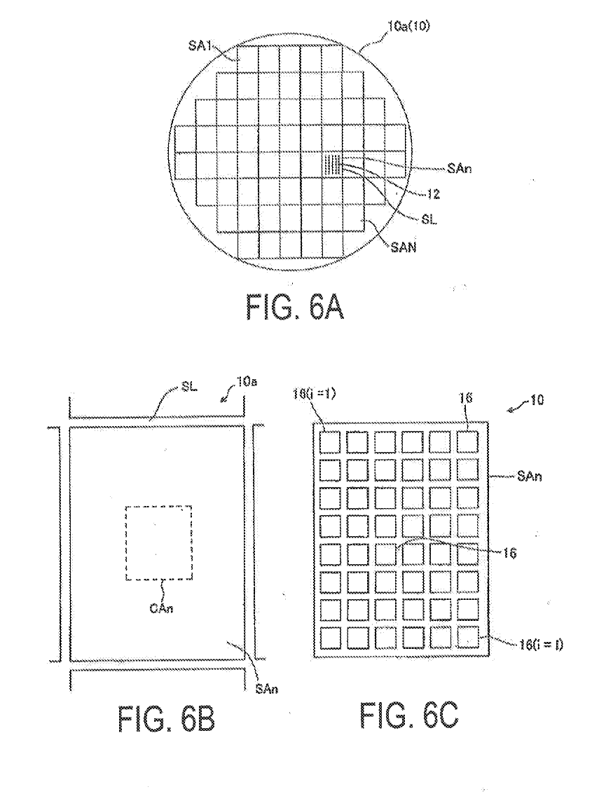

As an example, in a case where the incident angle θ1 is 15°, 30°, 45°, and 60°, images in which the Stokes parameter S2 obtained for every pixel of the wafer image is represented by changes in the signal intensity correspond to images AS21, AS22, AS23, and AS24 in FIG. 7A. In this example, when the incident angle is 45° (image A23), the changes in the signal intensity of the Stokes parameter S2 are larger. On the other hand, in a case where the incident angle θ1 is 15°, 30°, 45°, and 60°, images in which the Stokes parameter S3 obtained for every pixel of the wafer image is represented by changes in the signal intensity correspond to images AS31, AS32, AS33, and AS34 in FIG. 7B. In this example, when the incident angle is 15° (image AS31), the changes in the signal intensity of the Stokes parameter S3 are comparatively large.

Here, for the Stokes parameters S1 to S3 measured under all of the apparatus conditions described above, sensitivity (hereinafter, referred to as dose sensitivity), which is an absolute value of the ratio of a change in the measured value of the Stokes parameters to a change in the exposure amount, and sensitivity (hereinafter, referred to as focus sensitivity), which is an absolute value of the ratio of a change in the measured value of the Stokes parameters to a change in the focus position, were determined. At this time, it was found that the apparatus conditions under which the dose sensitivity is highest are different from each other for the respective parameters S1 to S3 and also that the apparatus conditions under which the focus sensitivity is highest are different from each other for the respective parameters S1 to S3.

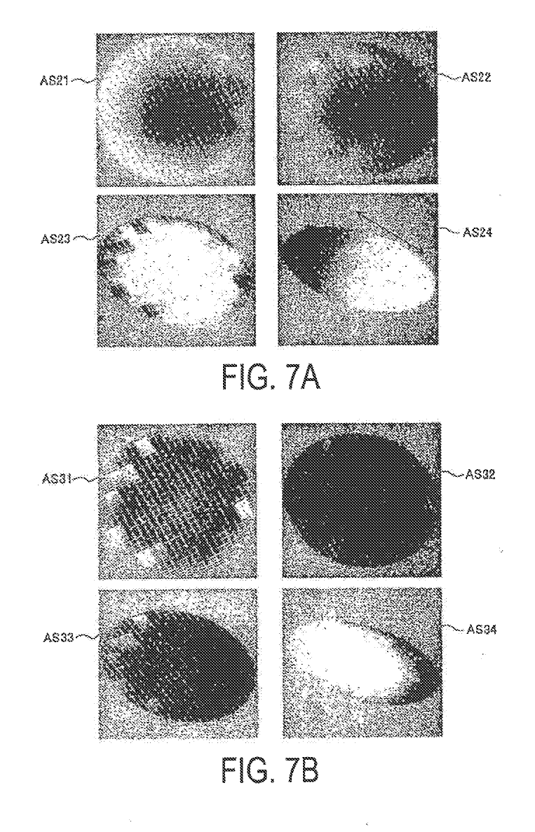

As an example, FIG. 8A shows the dose sensitivity of the Stokes parameters S1, S2, and S3 determined from the measurement results obtained by changing the incident angle θ1 from 15° to 60° at intervals of 5°, and FIG. 8A illustrates the focus sensitivity of the Stokes parameters S1, S2, and S3 determined from the measurement results obtained by changing the incident angle θ1 in the same manner. In the examples in FIGS. 8A and 8B, the incident angles θ1 (incident angle) where the dose sensitivity of the parameters S1, S2, and S3 is highest are 35°, 45°, and 40°, respectively, and the incident angles θ1 where the focus sensitivity of the parameters S1, S2, and S3 is highest are 15°, 25°, and 15°, respectively.

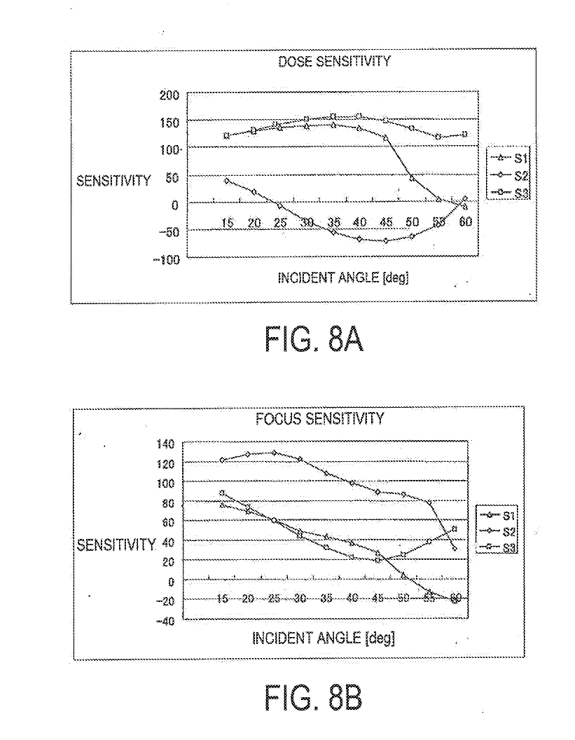

In addition, as another example, FIG. 9A shows the dose sensitivity and the focus sensitivity of the Stokes parameter S1 determined from the measurement results obtained using the rotating-retarder polarimetry by changing the rotation angle of the polarizer 26 of the light-receiving system 30 from 0° to 90° at intervals of 10°. Furthermore, FIGS. 9B and 9C respectively show the dose sensitivity and the focus sensitivity of the Stokes parameters S2 and S3 determined under the same conditions. In the example in FIG. 9A, the polarization angles where the dose sensitivity and the focus sensitivity of the parameter S1 are highest are 10° and 0°, respectively. In addition, in the example in FIG. 9B, the angles where the dose sensitivity and the focus sensitivity of the parameter S2 are highest are 60° and 90°, respectively. In the example in FIG. 9C, the angles where the dose sensitivity and the focus sensitivity of the parameter S3 are highest are 0° and 80°, respectively. As a result, in the parameters S1 to S3, the apparatus conditions under which the dose sensitivity is highest are different from each other, and the apparatus conditions under which the focus sensitivity is highest are also different from each other.

As shown in FIG. 8 and FIG. 9 described above, when the exposure amount changes, the Stokes parameters S1, S2, and S3 of the reflected light change, and when the focus position changes, the Stokes parameters S1 and S3 of the reflected light changes comparatively greatly while the Stokes parameter S2 hardly changes. For this reason, in the present embodiment, as an example, the exposure amount is determined using the Stokes parameters S2 and/or S3 and the focus position is determined using the Stokes parameter S3.

Therefore, using the shot average values of the Stokes parameters measured under all of the apparatus conditions described above, an apparatus condition (hereinafter, referred to as the first apparatus condition) under which the dose sensitivity of the Stokes parameters S2 and S3 is high and the focus sensitivity of the Stokes parameters S2 and S3 is low is determined in the second computing section 60b (step 132). Then, the first apparatus condition and the values of the Stokes parameters S2 and S3 corresponding to the respective exposure amounts obtained under the apparatus condition are set into a table (hereinafter, referred to as a template) and stored in the storage section 85.

In addition, an apparatus condition (hereinafter, referred to as the second apparatus condition) under which the focus sensitivity of the Stokes parameter S3 is high and the dose sensitivity of the Stokes parameter S3 is low is determined in the second computing section 60b. Then, the second apparatus condition and the values of the Stokes parameter S3 corresponding to the respective focus values obtained under the apparatus condition are set into a table (hereinafter, referred to as a template) and stored in the storage section 85 (step 134).

Specifically, the shot average values of the Stokes parameter S2 with respect to changes in the exposure amount measured under example apparatus conditions A, B, and C are respectively represented by the curves BS21, BS22, and BS23 in FIG. 10A, and the shot average values of the Stokes parameter S2 with respect to changes in the focus value measured under the apparatus conditions A, B, and C are respectively represented by the curves CS21, CS22, and CS23 in FIG. 10B. Furthermore, the shot average values of the Stokes parameter S3 with respect to changes in the exposure amount measured under apparatus conditions A, B, and C are respectively represented by the curves BS31, BS32, and BS33 in FIG. 10C, and the shot average values of the Stokes parameter S3 with respect to changes in the focus value measured under the apparatus conditions A, B, and C are respectively represented by the curves CS31, CS32, and CS33 in FIG. 10D. Here, the Stokes parameters S2 and S3 are normalized values, and the curve BS21 and the like represent data shown for convenience of explanation.

At this time, the first apparatus condition under which the dose sensitivity of the Stokes parameter S2 is high and the focus sensitivity is low is the apparatus condition A corresponding to the curve BS21 in FIG. 10A and the curve CS21 in FIG. 10B. Furthermore, the first apparatus condition under which the dose sensitivity of the Stokes parameter S3 is high and the focus sensitivity is low is the apparatus condition B corresponding to the curve BS32 in FIG. 10C and the curve CS32 in FIG. 10D. Furthermore, the second apparatus condition under which the focus sensitivity of the Stokes parameter S3 is high and the dose sensitivity is low is the apparatus condition A corresponding to the curve CS31 in FIG. 10D and the curve BS31 in FIG. 10C.

Accordingly, the data in which the values of the Stokes parameter S2 corresponding to the respective exposure amounts obtained under the first apparatus condition (here, apparatus condition A) are set in a table is stored in the storage section 85 as a template TD1. Similarly, the data in which the values of the Stokes parameter S3 corresponding to the respective exposure amounts obtained under the first apparatus condition (here, apparatus condition B) are set in a table is stored in the storage section 85 as a template TD2. Furthermore, the data in which the values of the Stokes parameter S3 corresponding to the respective focus values obtained under the second apparatus condition (here, apparatus condition A) are set in a table is stored in the storage section 85 as a template TF1. Here, FIGS. 11A and 11B show the appropriate ranges 50D and 50F (non-defective ranges) of the exposure amount and the focus value. Accordingly, in the present embodiment, the apparatus condition includes the first apparatus condition (apparatus conditions A and B) and the second apparatus condition (apparatus condition B) different from the first apparatus condition. Furthermore, it is also possible to regard the first apparatus condition as first inspection condition and the second apparatus condition as second inspection condition.

The condition setting for determining the first and second apparatus conditions to be used for determining the wafer exposure condition is completed through the operations described above.

Next, with respect to the wafer on which the repetitive pattern is formed by exposure using the exposure device 100 in the practical device manufacturing process, the exposure amount and the focus position in the exposure conditions of the exposure device 100 are determined as follows by measuring the Stokes parameters of the light reflected from the wafer surface using the two apparatus conditions obtained by the inspection apparatus 1 in the condition setting described above. It is also possible to refer to the inspection operation illustrated in the flow chart in FIG. 5 as dose and focus monitor. First, the wafer 10, which has the same shot arrangement as in FIG. 6A and which will be an actual product (for example, a semiconductor device) on which a resist is applied, is carried to the exposure device 100, each of the shots SAn (n=1 to N) of wafer 10 is exposed to a pattern of a reticle (not illustrated) for the practical product by the exposure device 100, and the wafer is developed after being exposed. At this time, the exposure conditions are set so that the exposure amount is an appropriate exposure amount determined according to the reticle and the focus position is an appropriate focus position.

However, in practice, due to the effects of, for example, slight illumination unevenness and shaking of the stage (including shaking due to disturbances) in the non-scanning direction in a slit-shaped illumination region, for example, during scanning and exposure in the exposure device 100, variations in the exposure amount and the focus position, or the like may occur in shots SAn of the wafer 10 (in the repetitive patterns of the shots SAn), and, in addition, variations in the exposure amount and the focus position, or the like may occur in a plurality of set regions 16 in each of the shots SAn, which may cause unplanned changes in the exposure amount (for example, changes from the appropriate exposure amount) and unplanned changes in the focus position (for example, changes from the appropriate focus value). Thus, the exposure amount and the focus position are separately evaluated.

Then, in step 150 in FIG. 5, the exposed and developed wafer 10 is loaded onto the stage 5 of the inspection apparatus 1 in FIG. 1A via an alignment mechanism (not illustrated). Then, the control section 80 reads out, from the recipe information of the storage section 85, the first and second apparatus conditions determined by the condition setting described above. Then, the apparatus condition is set to the first apparatus condition (here, the apparatus condition A for the Stokes parameter S2 among the apparatus conditions) under which the dose sensitivity of the Stokes parameters S2 and S3 is high (step 152), and the rotation angle of the quarter-wavelength plate 33 is set to the initial value (step 110A). Then, the wafer surface is irradiated with the illumination light ILI, and the imaging device 35 outputs the image signal of the wafer surface to the image processing section 40 (step 112A). Next, it is determined whether or not the quarter-wavelength plate 33 has been set to all of the angles (step 114A). In a case of not having been set to all of the angles, the quarter-wavelength plate 33 is rotated by, for example, approximately 1.41° (an angle obtained by dividing the rotation angle range of 360° by 256) (step 116), and, after proceeding to step 112A, the wafer 10 is imaged. Repeating step 112A until the quarter-wavelength plate 33 has been rotated 360° in step 14A results in 256 images of the wafer surface corresponding to the different rotation angles of the quarter-wavelength plate 33 being captured.

Thereafter, the flow proceeds to step 118A, and the image processing section 40 determines the Stokes parameters S2 and S3 for every pixel of the imaging device 35 from the obtained 256 digital images of the wafer using the rotating-retarder polarimetry described above. The Stokes parameters are outputted to the first computing section 60a of the inspection section 60, and, as an example, the shot average values of the Stokes parameters are determined in the first computing section 60a and outputted to the third computing section 60c and the storage section 85. Then, it is determined whether or not the determinations have been carried out under all of the apparatus conditions (step 154). In a case of not having set all of the apparatus conditions for determination, another apparatus condition is set in step 156, and then the flow proceeds to step 110A.

In the present embodiment, since the first apparatus condition with respect to the Stokes parameter S3 is the apparatus condition B, here, the apparatus condition B is set. Thereafter, steps 110A to 118A are repeated, and then the Stokes parameter (here, S3) is determined and stored for every pixel under the apparatus condition B. Furthermore, since the second apparatus condition under which the focus sensitivity of the Stokes parameter S3 is high is the same as the apparatus condition A here, the Stokes parameter S3 determined when the apparatus condition A is set is used as the Stokes parameter determined under the second apparatus condition. Here, typically, steps 110A to 118 are executed in a state where another apparatus condition is set as the second apparatus condition. Then, when it is determined in step 154 that the determinations under the first and second apparatus conditions have been completed, the flow proceeds to step 158.

Then, in step 158, the third computing section 60c of the inspection section 60 collates values (assumed to be S2x and S3x) of the Stokes parameters S2 and S3 for every pixel determined under the first apparatus condition with the templates TD1 and TD2 stored in step 132 described above to determine exposure amounts Dx1 and Dx2. Here, in practice, the exposure amounts Dx1 and Dx2 are approximately the same values. Furthermore, as an example, the average values of the exposure amounts Dx1 and Dx2 may be set as a measurement value Dx of the exposure amount. The distribution of the difference (error) of the measurement value Dx from the optimum exposure amount Dbe is supplied to the control section 80 and further displayed on a display device (not illustrated).

In addition, in step 160, the third computing section 60c collates a value (assumed to be S3y) of the Stokes parameter S3 for every pixel determined under the second apparatus condition with the template TF1 stored in step 134 to determine a focus value Fy. The distribution of the difference (error) of the measurement value Fy from the optimum focus position Zbe is supplied to the control section 80 and further displayed on a display device (not illustrated).

Thereafter, information about the error distribution of the exposure amount (exposure amount unevenness) for the entire surface of the wafer 10 and the error distribution of the focus position (defocus amount distribution) is provided from the signal output section 90 to a control section (not illustrated) of the exposure device 100 under the control of the control section 80 (step 162). Accordingly, for example, in order to correct the exposure conditions of the exposure amount and/or the focus position in a case where, for example, the dose unevenness and/or the defocus amount distribution each exceed a predetermined appropriate range, correction of the distribution of the width of the illumination region in the scanning direction during scanning and exposure, or the like is performed in the control section (not illustrated) of the exposure device 100, for example. Due to this, the errors in the exposure amount distribution and defocus amount are reduced during subsequent exposure. Thereafter, the wafer is exposed under the corrected exposure conditions in the exposure device 100 in step 164.

According to the present embodiment, the determination using the Stokes parameters under the two apparatus conditions with the wafer 10 on which formed is a pattern for a device which will be an actual product is performed, which makes it possible to estimate or determine the exposure amount and focus position with high accuracy in the exposure conditions of the exposure device 100 used when forming the pattern with both effects of the exposure amount and focus position eliminated.

As described above, the inspection apparatus 1 and the inspection method of the present embodiment are an apparatus and method for determining the exposure conditions of the non-planar repetitive pattern 12. The repetitive pattern 12 is provided on the wafer 10 by carrying out exposure under a plurality of exposure conditions including the exposure amount and the focus position. Then, the inspection apparatus 1 is provided with the stage 5 capable of holding the wafer 10 which has the pattern 12 formed on the surface thereof, the illumination system 20 which illuminates the surface of the wafer with the linearly polarized illumination light ILI (polarized light), the imaging device 35 and the image processing section 40 which receive light emitted from the surface of the wafer 10 and detect the Stokes parameters S1 to S3 (conditions for prescribing the polarization state) of the light, and the computing section 50 which determines the apparatus condition of the inspection apparatus 1 for determining the exposure condition of the inspection target pattern 12 formed on the surface of the wafer 10 on the basis of the Stokes parameters of the light emitted from the condition-parameterizing wafer 10a having the pattern 12 formed thereon under known exposure conditions. The inspection apparatus 1 determines the exposure conditions of the pattern 12 on the basis of the Stokes parameters of the light emitted from the surface of the wafer 10 under the apparatus condition determined by the computing section 50.

Furthermore, the inspection method of the present embodiment includes steps 112 and 112A of illuminating the surface of the wafer 10 which has the pattern 12 formed on the surface thereof with polarized light and receiving the light emitted from the surface of the wafer 10, steps 118 and 118A of detecting the Stokes parameters of the light, steps 132 and 134 of determining the apparatus condition (inspection condition) for determining the exposure conditions of the inspection target pattern 12 formed on the surface of the inspection target wafer 10 on the basis of the Stokes parameters of the light emitted from the condition-parameterizing wafer 10a which has the pattern 12 formed thereon under known exposure conditions, and steps 158 and 160 of determining the exposure conditions of the pattern 12 on the basis of the Stokes parameters of the light emitted from the surface of the wafer 10 under the determined apparatus condition.

According to this embodiment, by using the wafer 10 having the non-planar repetitive pattern 12 provided by exposure under a plurality of exposure conditions as a plurality of processing conditions, it is possible to estimate and determine, with high accuracy, each of the exposure amount and focus position out of the plurality of exposure conditions with the effects of other exposure conditions suppressed. Furthermore, it is not necessary to use a separate evaluation pattern and it is possible to determine the exposure conditions by detecting light from the wafer on which the pattern for a device which will be an actual product is formed, which makes it possible to efficiently and highly accurately determine the exposure conditions for the pattern used for actual exposure.

Furthermore, in the present embodiment, the first and second apparatus conditions to be used during the inspection of the exposure conditions are conditions in which changes in the Stokes parameters S2 and S3 of the light emitted from the condition-parameterizing wafer 10a on which the pattern is formed under the exposure condition combining the known first and second exposure conditions (the exposure amount and the focus position) are greater than in a case where other exposure conditions change with respect to the change (sensitivity) in each of the first and second exposure conditions. Accordingly, it is possible to determine the first and second exposure conditions with the effects of other exposure conditions further suppressed.

Furthermore, the exposure system of the present embodiment is provided with the exposure device 100 (exposure section) having a projection optical system for exposing a wafer surface to a pattern, and the inspection apparatus 1 of the present embodiment. In such an exposure system, the exposure conditions in the exposure device 100 are corrected according to the first and second exposure conditions determined by the computing section 50 of the inspection apparatus 1.

Furthermore, the exposure method of the present embodiment determines the first and second exposure conditions of the wafer using the inspection method of the present embodiment (steps 150 to 160), and corrects the exposure conditions during exposure of the wafer according to the first and second exposure conditions estimated by the inspection method (step 162).

As a result, the exposure conditions in the exposure device 100 are corrected according to the first and second exposure conditions estimated by the inspection apparatus 1 or the inspection method using the inspection apparatus 1, which makes it possible to efficiently and highly accurately set the exposure conditions in the exposure device 100 to a desired state using the wafer to be used for manufacturing a practical device.

Furthermore, in the embodiment described above, the first and second apparatus conditions are determined corresponding to the exposure amount and the focus position; however, for example, an apparatus condition with high sensitivity, independently with respect to the under-dose and the over-dose may be determined, and an apparatus condition with high sensitivity, independently with respect to the under-focus and the over-focus may be determined.

Here, in the present embodiment, linearly polarized light obtained by the polarizer 26 converting light from the light source 22 to linearly polarized light illuminates the wafer, but the light which illuminates the wafer need not be limited to linearly polarized light (refer to FIG. 1A). For example, the wafer may be illuminated with circularly polarized light. In such a case, for example, a half-wavelength plate in addition to the polarizer 26 is provided, and thus the light from the light source 22 is converted to circularly polarized light by the polarizer 26 and the half-wavelength plate and then illuminates the wafer. Furthermore, the wafer may also be illuminated with elliptically polarized light other than the circularly polarized light. Regarding the configuration for converting the light from the light source 22 to linearly polarized light or elliptically polarized light (elliptically polarized light including circularly polarized light), it is also possible to apply a known configuration other than the above configuration. Furthermore, it is also possible to use a light source which emits linearly polarized light or elliptically polarized light as the light source 22 other than a light source which emits non-polarized light, such as a metal halide lamp or a mercury lamp. In such a case, it is possible to omit the polarizer 26.

Here, in the present embodiment, the quarter-wavelength plate 33 is arranged on the optical path of the light reflected by the light-receiving-side concave mirror 31 of the light-receiving system 30; however, the present embodiment is not limited to this arrangement. For example, the quarter-wavelength plate 33 may be arranged in the illumination system 20. Specifically, in the illumination system 20, the quarter-wavelength plate 33 may be arranged on the optical path of the light passing from the light guiding fiber 24 through the polarizer 26. In such a case, the quarter-wavelength plate 33 is arranged on the optical path between the polarizer 26 and the illumination-side concave mirror 25.

Here, in the present embodiment, the exposure conditions of the exposure device 100 are evaluated on the basis of the Stokes parameters calculated using the specularly reflected light from the surface of the wafer 10 received by the light-receiving system 30; however, the light need not be limited to specularly reflected light. For example, diffracted light from the surface of the wafer 10 is received by the light-receiving system 30, and then the exposure conditions may be evaluated on the basis of the calculated Stokes parameters. In such a case, the control section 80 controls the light-receiving system 30 on the basis of known diffraction conditions such that the light-receiving system 30 receives diffracted light from the surface of the wafer 10.

Here, the plurality of apparatus conditions in the present embodiment include the wavelength λ of the illumination light ILI, the incident angle θ1 (emission angle θ2 of the reflected light) of the illumination light ILI, and the rotation angle of the polarizer 26; however, at least one of the wavelength λ, the incident angle θ1, and the rotation angle of the polarizer 26 may be included. Furthermore, the apparatus conditions are not limited to these conditions. It is possible for the apparatus conditions to be other desired conditions adjustable in the inspection apparatus 1. For example, the rotation angle of the analyzer 32 (orientation of the transmission axis), the rotation angle of the stage 5 (orientation of the wafer 10), and the like may be set as apparatus conditions.

Here, in the present embodiment, the signal output section 90 need not output the determination results of the obtained exposure conditions to the exposure device 100. For example, the signal output section 90 may output the determination results of the exposure conditions to a host computer (not illustrated) carrying out overall control of the operations of a plurality of exposure devices or the like.

In such a case, in step 162 in FIG. 5, information about the error distribution of the exposure amount (exposure amount unevenness) for the entire surface of the wafer 10 and the error distribution of the focus position (defocus amount distribution) may be provided from the signal output section 90 to a host computer (not illustrated). Then, on the basis of the information thus provided, the host computer (not illustrated) may send a command for correcting the exposure conditions (at least one of the exposure amount and focus position) to the exposure device 100 or to a plurality of exposure devices including the exposure device 100. Furthermore, for example, on the basis of the obtained exposure condition determination results, the signal output section 90 may provide a warning to the effect that the exposure conditions are not appropriate to the exposure device 100 or the host computer.

Here, in the present embodiment, the Stokes parameters are determined by rotating the quarter-wavelength plate 33 approximately 1.41° (the angle obtained by dividing the rotatable angle range of 360° by 256) at a time and capturing 256 images of the wafer 10 according to the rotating-retarder polarimetry; however, 256 images of the wafer 10 need not be captured with the angle of the quarter-wavelength plate 33 set to 256 different angles. Since there are four (S0 to S3) unknown numbers relating to the Stokes parameters, the angle of the quarter-wavelength plate 33 may be set to four different angles and, at least only four images of a wafer 10d may be captured.

Here, in the present embodiment, the Stokes parameters S0 to S3 are outputted to the first computing section 60a of the inspection section 60, and the average values (shot average values) for every shot of the Stokes parameters S0 to S3 are determined in the first computing section 60a; however, it is not limited to the average values for every shot. For example, the Stokes parameters of pixels corresponding to the insides of all of the shots SAn (refer to FIG. 6B) excluding the scribe line regions SL of the condition-parameterizing wafer 10a may be calculated, and the calculated results may be averaged. As illustrated in FIG. 6C, the average values of the Stokes parameters for every set region 16 in a shot may be determined. This is because calculating the shot average values in this manner suppresses the effects of aberration or the like in the projection optical system of the exposure device 100. Here, in order to further suppress the effects of the aberration or the like, for example, a value obtained by averaging the Stokes parameters of pixels corresponding to the inside of a partial region CAn located in the center portion of the shot SAn in FIG. 6B may be calculated. Furthermore, the average value of every pixel corresponding to a plurality of shots may be calculated.

However, it is also possible to find the effects of aberration (error distribution imparted on the digital image) in the projection optical system in advance and correct the effects of the aberration when the digital image is generated. In such a case, instead of the shot average value, the average value may be calculated for every I (I is, for example, an integer of several tens) set regions 16 (refer to FIG. 6C) with a rectangular shape or the like in the shots SAn, and, for example, subsequent processes may be performed using the average value of the set regions 16 located at the same position in the shots SAn. The arrangement of the set regions 16 has six rows in the scanning direction and five columns in the non-scanning direction, for example, but any desired size and arrangement may be used.

Here, in the condition setting of the present embodiment, an apparatus condition (apparatus condition A) under which the dose sensitivity of the Stokes parameter S2 is high and the focus sensitivity is low, and an apparatus condition (apparatus condition B) under which the dose sensitivity of the Stokes parameter S3 is high and the focus sensitivity is low are determined (the first apparatus condition is determined); however, the present embodiment is not limited to this method. For example, the Stokes parameters S2 and S3 may be calculated with a desired calculation formula such that the difference between the dose sensitivity and the focus sensitivity of the target Stokes parameter is further increased (the second apparatus condition may also be calculated using a calculation formula in the same manner). It is possible to use various calculation formulas for the calculation formulas of the Stokes parameters S2 and S3, and, for example, calculation formulas such as [S2+S3](sum), [S2²+S3²](sum of squares), and the like may be used. The exposure conditions are evaluated under the apparatus condition of the inspection apparatus 1 determined by using a desired calculation formula as described above, which makes it possible to evaluate the exposure conditions with higher accuracy compared to the method for determining the two apparatus conditions separately for the Stokes parameters S2 and S3.

Here, in the condition setting of the present embodiment, the exposure conditions of the exposure device 100 used in the condition setting are determined using the templates TD1, TD2, and TF1 determined using the condition-parameterizing wafer 10a on which the repetitive pattern is formed by the exposure device 100; however, the exposure conditions (the exposure amount and the focus position) of a device different from the exposure device 100 may be determined using the templates TD1, TD2, and TF1.

Here, in the condition setting of the present embodiment, the Stokes parameters S0 to S3 are calculated; however, since the Stokes parameter S0 represents the total intensity of the light flux, only the Stokes parameters S1 to S3 need to be determined in order to determine the exposure conditions. Furthermore, the Stokes parameters are determined for every pixel of the imaging element 35b, but may be determined for each of a plurality of pixels. For example, the Stokes parameters may be determined for each of 2×2 pixels. Furthermore, in the present embodiment, when the exposure amount changes, the Stokes parameters S1, S2, and S3 of the reflected light change, and when the focus position changes, the Stokes parameters S1 and S3 of the reflected light change comparatively greatly while the Stokes parameter S2 hardly changes (refer to FIGS. 3A and 3B). For this reason, since it is possible to separately determine the conditions of the exposure amount and the focus position from only the Stokes parameters S2 and S3, only the Stokes parameters S2 and S3 need to be determined.

Here, in the condition setting of the present embodiment, an FEM wafer is used as the condition-parameterizing wafer 10a; however, a wafer (hereinafter, referred to as a non-defective wafer) on which all shots are formed under appropriate exposure conditions may be used in addition to the FEM wafer. In such a case, firstly, the shot average value of the Stokes parameters of the non-defective wafer is calculated in step 118 in FIG. 4. Next, differences in the shot average values between the shots on the FEM wafer and the shots on the non-defective wafer which are located at the same positions as each other on the wafers are calculated. Then, on the basis of the calculated difference values (in other words, the amount of change in the Stokes parameters according to changes in the exposure conditions from the appropriate values), a first apparatus condition under which the dose sensitivity is high and the focus sensitivity is low, and a second apparatus condition under which the focus sensitivity is high and the dose sensitivity is low are determined. Here, it is not limited to the differences in the shot average values, and ratios or the like may be calculated.

Here, in the present embodiment, in order to determine the exposure conditions of the pattern for a device which will be an actual product, the Stokes parameters S2 and S3 are used in the evaluation of the exposure amount, and the Stokes parameter S3 is used in the evaluation of the focus position; however, the type of the Stokes parameter to be used is not limited thereto. For example, the Stokes parameters S1 and S2 may be used in the evaluation of the exposure amount, and the Stokes parameters S1 and S3 may be used in the evaluation of the focus position. Furthermore, in the evaluation of the exposure amount, since the Stokes parameter S1 changes corresponding to changes in both of the exposure amount and the focus position, the determination of the exposure amount may be performed using the Stokes parameter S1 (or at least one parameter selected from S1, S2, and S3), and the determination of the focus position may be performed using the Stokes parameter S1 (or at least one parameter selected from S1, and S3). Furthermore, in a case where changes in the elliptically polarized light from the wafer surface with respect to changes in each of the exposure amount and the focus position are not the changes illustrated in FIGS. 3A and 3B, the type of the Stokes parameter may be selected as appropriate so as to determine the first apparatus condition and the second apparatus condition on the basis of changes in the Stokes parameters with respect to changes in the exposure amount and changes in the Stokes parameters with respect to changes in the focus position.

Here, in the present embodiment, the templates stored in the storage section 85 in step 132 and step 134 are templates in which the values of desired Stokes parameters corresponding to respective desired exposure conditions are set into a table; however, the templates are not limited thereto, and, for example, may be curves or approximate expressions obtained by mathematically fitting the values of desired Stokes parameters with respect to desired exposure conditions using a desired function. For example, in FIGS. 11A and 11B, the curves BS21 and BS32 showing changes in the Stokes parameters S2 and S3 with respect to the exposure amount obtained under the first apparatus condition (here, the apparatus conditions A and B) may be set as templates TD1 and TD2, or respective approximate expressions for the curves BS21 and BS32 may be set as the templates TD1 and TD2. In the same manner, the curve CS 32 obtained under the second apparatus condition (here, the apparatus condition A) may be set as the template TF1, or an approximate expression for the curve CS32 may be set as the template TF1.

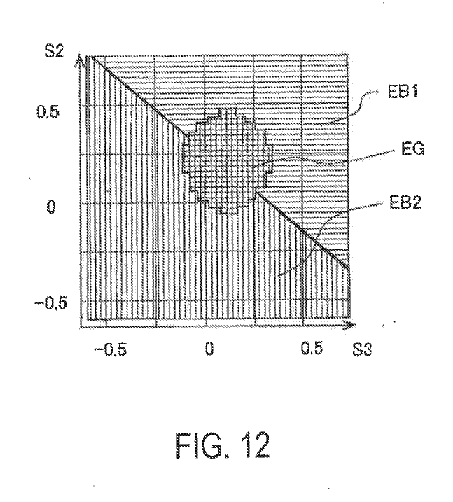

Furthermore, as illustrated in FIG. 12, in the two-dimensional distribution of the Stokes parameters S2 and S3, an appropriate range EG, a range EB1 of an exposure amount exceeding the appropriate range, and a range EB2 of an exposure amount less than the appropriate range are set, and such a two-dimensional distribution may be a template for determining whether it is defective or non-defective. In such a case, the values of the parameters S2 and S3 are represented by (S2, S3), and a non-defective range EG may be approximately set as follows as the inside of a circle where the radius is sr and the center coordinates are (sa, sb). When the value obtained by substituting the parameter values (S2, S3) to be measured into the calculation formula on the left side of the following formula (formula 5) satisfies the following formula (formula 5), the measured values represent a non-defective product.

(S2−sa)²+(S3−sb)²≦sr² [Formula 5]

In such a case, using the two-dimensional template in FIG. 12, it is determined whether the exposure amount of a pixel in question is in an appropriate range, a range of an exposure amount exceeding the appropriate range, or a range of an exposure amount less than the appropriate range from the values (S2x, S3x) of the Stokes parameters S2 and S3 and the information about the determination result may be supplied to the control section 80.

Here, in step 158 and step 160 of the present embodiment, a difference between the measured value Dx and the appropriate exposure amount Dbe and a difference between the measured value Fy and the appropriate focus position Zbe need not be calculated. For example, various calculation methods may be used for the measured value Dx and the measured value Fy calculated in step 158 and step 160, the ratio of the measured value Dx to the appropriate exposure amount Dbe and the ratio of the measured value Fy to the appropriate focus position Zbe, and the like. Furthermore, the determination results of the exposure conditions need not be displayed on a display device (not illustrated).

In addition, in the embodiment described above, the exposure amount and the focus position are determined as the exposure conditions; however, the determination in the embodiment described above may be used in order to determine the wavelength of the exposure light in the exposure device 100, the illumination conditions (for example, coherence factor (σ value)), the numerical aperture of the projection optical system PL, the temperature of the liquid during liquid immersion exposure, or the like as the exposure conditions.

### Second Embodiment

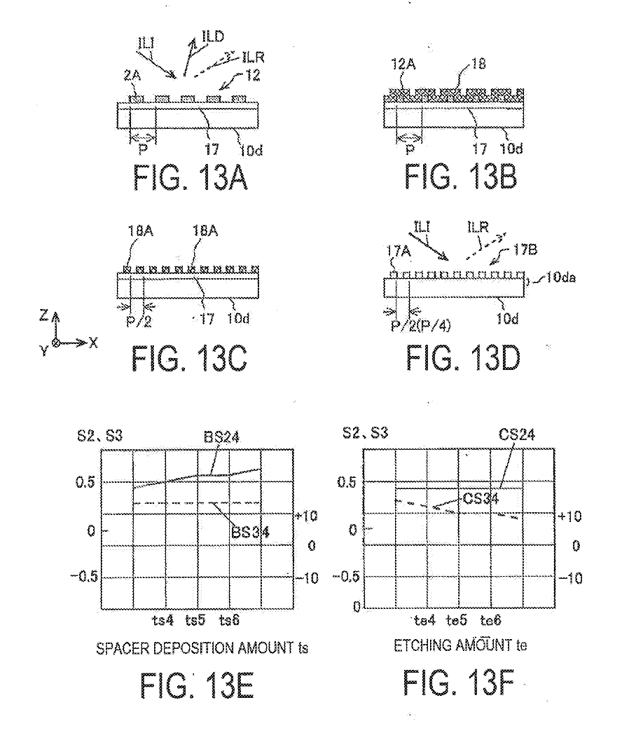

A second embodiment will be described with reference to FIGS. 13A to 15. In the present embodiment, the inspection apparatus 1 in FIG. 1A is used in order to determine processing conditions of a device manufacturing system (not illustrated). Furthermore, in the present embodiment, the processing conditions for a wafer on which a fine-pitched repetitive pattern is formed are determined using a so-called spacer double patterning (or a side wall double patterning). Here, in the present embodiment, the device manufacturing system includes the exposure device 100, a thin film forming device (not illustrated), and an etching device (not illustrated).

In spacer double patterning, first, the repetitive pattern 12 in which line sections 2A which are a plurality of resist patterns are arranged at a pitch P is formed by, for example, application of a resist onto the surface of a hard mask layer 17 of the wafer 10d and pattern exposure and development using the exposure device 100, as illustrated in FIG. 13A. As an example, the pitch p is close to the resolution limit of the exposure device 100. Thereafter, as illustrated in FIG. 13B, the line width of the line sections 2A is halved by performing etching (so-called slimming) on the line sections 2A (the line sections where the width thereof is halved are referred to as line sections 12A) using the etching device (not illustrated), and spacer layers 18 are deposited by the thin film forming device (not illustrated) so as to cover the line sections 12A. Thereafter, after etching the spacer layers 18 of the wafer 10d by a predetermined thickness with the etching device (not illustrated), only the line sections 12A are removed using the etching device, and then, as illustrated in FIG. 13C, a repetitive pattern having a plurality of spacer sections 18A arranged on the hard mask layer 17 at a pitch P/2 is formed in which the line width of spacer sections 18A is approximately P/4. Then, the hard mask layer 17 is etched using the plurality of spacer sections 18A as masks, and then, as illustrated in FIG. 13D, a repetitive pattern 17B having hard mask sections 17A arranged at the pitch P/2 is formed in which the line width of the hard mask sections 17A is approximately P/4. Thereafter, as an example, a device layer 10da of the wafer 10d is etched using the repetitive pattern 17B as a mask, thereby enabling a repetitive pattern having a pitch which is approximately ½ the resolution limit of the exposure device 100 to be formed. In addition, a repetitive pattern having a pitch of P/4 can also be formed by repeating the aforementioned processes.

Furthermore, in a case where diffraction inspection is performed using the inspection apparatus 1, the pitch of the repetitive pattern needs to be no less than ½ the wavelength λ of the illumination light ILI of the inspection apparatus 1 in order for diffraction to occur. As a consequence, in the case where light having a wavelength of 248 nm is used as the illumination light, the diffracted light ILD is not produced by the repetitive pattern 12 having the pitch P of not more than 124 nm. Accordingly, the diffraction inspection becomes progressively more difficult as the pitch P approaches the resolution limit of the exposure device 100, as in the case in FIG. 13A. In addition, only the specularly reflected light ILR is generated with the repetitive pattern 17B having a pitch of P/2 (and furthermore, of P/4), as in the case in FIG. 13D, which makes diffraction inspection difficult.

In the inspection apparatus 1 of the present embodiment, since specularly reflected light is detected in order to measure the Stokes parameters, as illustrated in FIG. 13D, it is possible to determine the processing conditions of the repetitive pattern 17B with high accuracy by detecting the light from the wafer 10d on which the repetitive pattern 17B that does not generate diffracted light is formed in each of the shots.

In the present embodiment, in an operation (condition setting) for selecting a plurality of apparatus conditions to be used for determining the processing conditions from the Stokes parameters of the light reflected from the pattern 17B of the wafer 10d, it is assumed that the etching amount te of the spacer layer 18 in FIG. 13B and the deposition amount ts (thin film deposition amount) of the spacer layer 18 are set as the processing conditions of the repetitive pattern 17B in the device manufacturing system (not illustrated).

Furthermore, in the present embodiment, the Stokes parameters to be used in the evaluation of the deposition amount ts and the etching amount te of the spacer layers 18 are set to S2 and S3 in the same manner as the first embodiment described above. Here, using the Stokes parameters S2 and S3 in the evaluation of the deposition amount ts and the etching amount te of the spacer layers 18 are merely examples and, in the present embodiment, the type of the Stokes parameters to be used in the evaluation of the deposition amount ts and the etching amount te of the spacer layers 18 may be selected in consideration of the size of changes in each of the Stokes parameters S0 to S3 with respect to the changes in the deposition amount ts and the size of changes in each of the Stokes parameters S0 to S3 with respect to changes in the etching amount te. That is, Stokes parameters where the changes with respect to changes in the deposition amount ts are large and the changes with respect to changes in the etching amount te are small may be selected from S0 to S3, and Stokes parameters where the changes with respect to changes in the etching amount te are large and the changes with respect to changes in the deposition amount ts are small may be selected from S0 to S3.

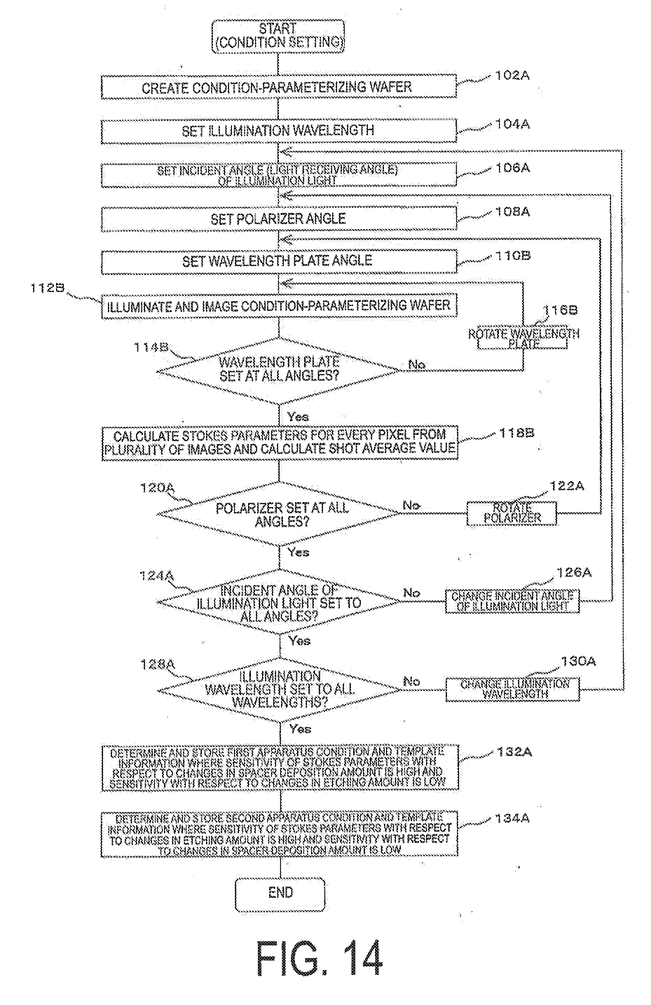

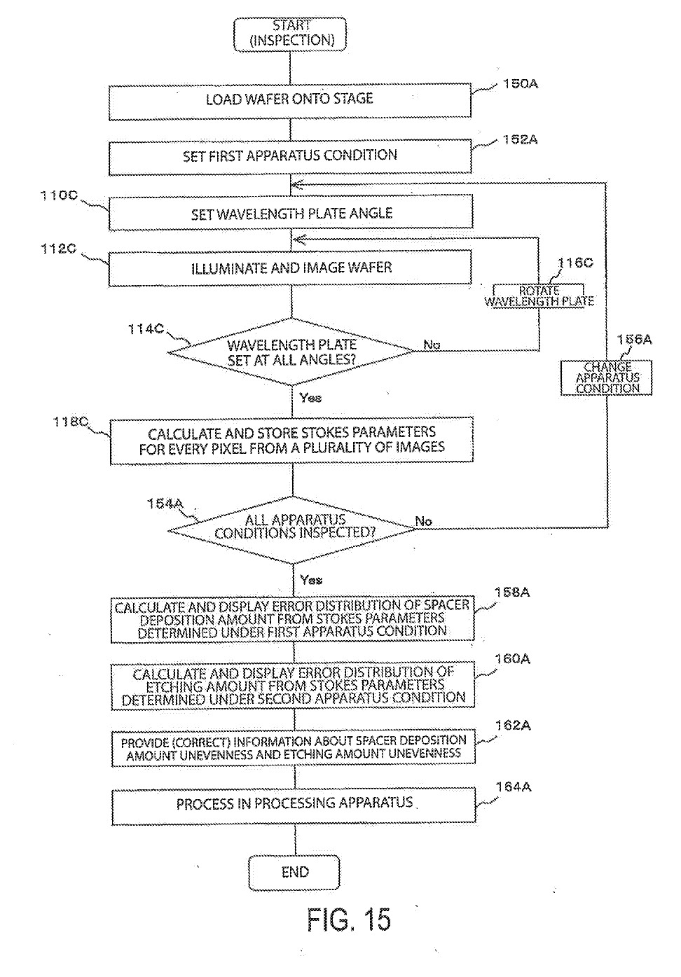

Below, in the present embodiment, with reference to the flow chart in FIG. 15, description will be given of an example of a method for determining processing conditions of the device manufacturing system used when forming the pattern by detecting light from the repetitive pattern 17B on the wafer surface using the inspection apparatus 1. Furthermore, description will be given of an example of a method for determining the apparatus condition (inspection condition) to be used during the above determination with reference to the flow chart in FIG. 14. These operations are controlled by the control section 80. Here, in FIG. 14 and FIG. 15, similar reference numerals are given to the steps corresponding to the steps in FIG. 4 and FIG. 5, and description thereof will be omitted or simplified.

First, for the condition setting, a condition-parameterizing wafer is created in step 102A in FIG. 14. In such a case, the spacer double patterning process in FIGS. 13A to 13D is performed 25 (=5×5) times, for example, combining five types of deposition amounts ts (ts3 to ts7) and five types of etching amounts (te3 to te7), to form the repetitive pattern 17B in each shot of condition-parameterizing wafers (not illustrated). Here, the deposition amount ts5 is an appropriate deposition amount, and the etching amount te5 is appropriate etching amount. As an example, the etching amounts te3 and te4 represent insufficient etching, whereas the etching amounts te6 and te7 represent excessive etching.

The plurality (here, 25) of created condition-parameterizing wafers are sequentially carried onto the stage 5 of the inspection apparatus 1 in FIG. 1A. Then, in each of the plurality of condition-parameterizing wafers, the operations in steps 102A to 130A are performed.

That is, each of the condition-parameterizing wafers (not illustrated) is carried onto the stage 5 of the inspection apparatus 1. Then, the control section 80 reads out a plurality, of apparatus conditions from the recipe information stored in the storage section 85. As an example of the plurality of apparatus conditions, apparatus conditions ∈ (n−m−j) are assumed in which the wavelength λ of the illumination light ILI is any one of λn (n=1 to 3) described above, the incident angle θ1 of the illumination light ILI is any one of αm (m=1 to 4) (for example, 15°, 30°, 45°, and 60°), and the rotation angle of the polarizer 26 is set to a plurality of angles βj (j=1 to J, J is an integer of 2 or more) at intervals of, for example, approximately 5° centering on a crossed Nicols state.

Then, in the inspection apparatus 1, the wavelength of the illumination light ILI is set to λ1 (step 104A), the incident angle θ1 is set to α1 (step 106A), the rotation angle of the polarizer 26 is set to β1 (step 108A), and the rotation angle of the quarter-wavelength plate 33 is set to the initial value (step 110B). Then, under these apparatus conditions, the surface of the condition-parameterizing wafer is illuminated with illumination light ILI, and the imaging device 35 images the condition-parameterizing wafer and outputs the image signal to the image processing section 40 (step 112B). Next, it is determined whether or not the quarter-wavelength plate 33 has been set to all of the angles (step 114B). In a case of not having been set to all of the angles, the quarter-wavelength plate 33 is rotated by, for example, approximately 1.41° (the angle obtained by dividing the rotatable angle range of 360° of the quarter-wavelength plate 33 by 256) (step 116B), and then the flow returns to step 112B and the condition-parameterizing wafer is imaged. Repeating step 112B until the quarter-wavelength plate 33 has been rotated 360° in step 114B results in 256 wafer images corresponding to the different rotation angles of the quarter-wavelength plate 33 being captured.

Thereafter, the flow proceeds from step 114B to step 118B, and the image processing section 40 determines the Stokes parameters S0 to S3 for every pixel of the imaging element 35b from the obtained 256 digital images of the wafer using the rotating-retarder polarimetry described above. The Stokes parameters S0 to S3 are outputted to the first computing section 60a of the inspection section 60, and, as an example, the average values (hereinafter, referred to as shot average values) of the Stokes parameters for each wafer are determined in the first computing section 60a and outputted to the second computing section 60b and the storage section 85. This is because, for the determining of the wafer average value, the processing conditions (here, the deposition amount of the spacer layer and the etching amount of the spacer layer) for each of the condition-parameterizing wafers of the present embodiment are the same.

In such a case, the Stokes parameters of the pixels corresponding to the insides of all of the shots SAn (refer to FIG. 6B) excluding the scribe line regions SL of the condition-parameterizing wafer are calculated, and the calculated results may be averaged inside the wafer.

Thereafter, the calculation of the Stokes parameters or the like is performed (steps 122A and 110B to 118B) for every pixel of the image of the wafer surface using the rotating-retarder polarimetry until the rotation angle of the polarizer 26 has been set to all of the angles βj (j=1 to J). Thereafter, the flow proceeds from step 120A to step 124A, and then the calculation of the Stokes parameters or the like is performed (steps 126A and 108A to 120A) for every pixel of the image of the wafer surface using the rotating-retarder polarimetry until the incident angle θ1 has been set to all of the angles αm (m=1 to 4). Thereafter, the flow proceeds from step 124A to step 128A, and then the calculation of the Stokes parameters or the like is performed (steps 130A and 106A to 124A) for every pixel of the image of the wafer surface using the rotating-retarder polarimetry until the wavelength λ has been set to all of the wavelengths λn (n=1 to 3). Thereafter, the flow proceeds from step 128A to step 132A.

Next, using the information about the Stokes parameters (here, set as S2 and S3) measured under all of the apparatus conditions described above, in the second computing section 60b of the inspection section 60, an apparatus condition under which the absolute value (hereinafter, referred to as the deposition amount sensitivity) of the ratio of the changes in the Stokes parameter S2 with respect to changes in the deposition amount ts of the spacer layer is high and the absolute value (hereinafter, referred to as the etching sensitivity) of the ratio of the changes in the Stokes parameter S2 with respect to changes in the etching amount te is low are determined as the first apparatus condition, and a template in which the values of the Stokes parameter S2 with respect to changes in the deposition amount ts of the spacer layer obtained under the first apparatus condition are set into a table is stored in the storage section 85 (step 132A). In addition, in the second computing section 60b, an apparatus condition under which the etching sensitivity of the Stokes parameter S3 is high and the deposition amount sensitivity is low is determined as the second apparatus condition, and a template in which the values of the Stokes parameter S3 with respect to changes in the etching amount ts obtained under the second apparatus condition are set into a table is stored in the storage section 85 (step 134A).

Specifically, for example, the changes in the Stokes parameter S2 (wafer average value) with respect to the deposition amount ts of the spacer layer measured under a certain apparatus condition D are represented by the curve BS24 in FIG. 13E, and the changes with respect to the etching amount te are represented by the curve CS24 in FIG. 13F. Furthermore, the changes in the Stokes parameter S3 with respect to the deposition amount ts of the spacer layer measured under a certain apparatus condition E are represented by the curve BS34 in FIG. 13E, and the changes with respect to the etching amount te are represented by the curve CS34 in FIG. 13F. Here, the Stokes parameters S2 and S3 are normalized values, and the curve BS24 and the like are data shown for convenience of explanation. Furthermore, for convenience of explanation, the apparatus conditions of the inspection apparatus 1 are represented by curves (changes in the Stokes parameters with respect to changes in the processing conditions) for only two conditions (apparatus condition D and apparatus condition E) from the apparatus conditions ∈.

At this time, the apparatus condition D is the first apparatus condition under which the deposition amount sensitivity of the Stokes parameter S2 is high and the etching sensitivity is low. Furthermore, the apparatus condition E is the second apparatus condition under which the deposition amount sensitivity of the Stokes parameter S3 is high and the etching sensitivity is low. Accordingly, data in which the values indicating the changes in the Stokes parameter S2 with respect to the deposition amount ts of the spacer layer obtained under the first apparatus condition (here, the apparatus condition D) are set into a table is stored in the storage section 85 as a first template relating to the deposition amount of the spacer layer. Furthermore, data in which the values indicating the changes in the Stokes parameter S3 with respect to the etching amount is obtained under the second apparatus condition (here, the apparatus condition E) are set into a table is stored in the storage section 85 as a second template relating to the etching amount. Respective appropriate ranges are set to these curves BS24 and CS24.

The condition setting for determining the first and second apparatus conditions to be used for determining the processing conditions of the pattern 17B of the wafer is completed through the operations described above.

Next, with respect to the wafer 10d on which the repetitive pattern 17B is formed in the practical device manufacturing process, the deposition amount ts of the spacer layer and the etching amount te of the spacer layer under the processing conditions are determined by measuring the Stokes parameters using the inspection apparatus 1. For that, in step 150A in FIG. 15, the manufactured wafer 10d is loaded onto the stage 5 of the inspection apparatus 1 in FIG. 1A via an alignment mechanism (not illustrated). Then, the control section 80 reads out the first and second apparatus conditions determined by the condition setting described above from the recipe information stored in the storage section 85. Then, the apparatus condition is set to the first apparatus condition (apparatus condition D) under which the sensitivity of the Stokes parameter S2 is high with respect to the changes in the deposition amount of the spacer layer (step 152A), and the rotation angle of the quarter-wavelength plate 33 is set to an initial value (step 110C). Then, the wafer surface is irradiated with the illumination light ILI, and the imaging device 35 outputs the image signal of the wafer surface to the image processing section 40 (step 112C). Next, by repeating the operation in which the quarter-wavelength plate 33 is rotated by, for example, 360°/256 (step 116C), and the wafer 10d is imaged (step 112C) until it is determined that the quarter-wavelength plate 33 has been rotated 360° in step 114C, 256 images of the wafer surface corresponding to the different rotation angles of the quarter-wavelength plate 33 are captured.

Thereafter, the flow proceeds to step 118C, and the image processing section 40 determines the Stokes parameter S2 for every pixel of the imaging device 35 from the obtained 256 digital images of the wafer using the rotating-retarder polarimetry described above. The Stokes parameters are outputted to the first computing section 60a of the inspection section 60, and the average values (shot average values) of the Stokes parameters are determined for every shot in the first computing section 60a and outputted to the third computing section 60c and the storage section 85. Here, since the determination under the second apparatus condition is not finished, the flow proceeds from step 154A to step 156A, and returns to step 110C after the apparatus condition is set to the second apparatus condition (apparatus condition E).

Thereafter, steps 110C to 118C are repeated, and then the shot average values of the Stokes parameters S3 are determined under the second apparatus condition and stored. Thereafter, the flow proceeds to step 158A.

Here, in step 158A, the third computing section 60c of the inspection section 60 collates the value (assumed to be S2Ax) of the Stokes parameter S2 for every pixel determined under the first apparatus condition with the first template stored in step 132A described above to determine a deposition amount tsx of the spacer layer. The distribution of the difference (error) of the measured value tsx from the optimum value of the deposition amount of the spacer layer is supplied to the control section 80 and further displayed on a display device (not illustrated) as necessary.

In addition, in step 160A, the third computing section 60c collates the value (assumed to be S3Ay) of the Stokes parameter S3 for every pixel determined under the second apparatus condition with the second template stored in step 134A to determine an etching amount tey. The distribution of the difference (error) of the measured value tey from the optimum value of the etching amount is supplied to the control section 80 and further displayed on a display device (not illustrated) as necessary.

Here, in step 158A and step 160 of the present embodiment, the differences of the measured values tsx and tey from the optimum values need not be calculated. For example, the ratios of the measured values tsx and tey calculated in step 158A and step 160A with respect to the optimum values or the like may be determined.

Thereafter, information about the error distribution (unevenness in the deposition amount of the spacer layer) in the deposition amount of the spacer layer and the error distribution (unevenness in the etching amount) in the etching amount of the spacer over the entire surface of the wafer is provided under the control of the control section 80 from the signal output section 90 to a control section (not illustrated) such as a host computer of a device manufacturing system (step 162A). Accordingly, in the control section (not illustrated) of the device manufacturing system, for example, in a case where the unevenness in the deposition amount of the spacer layer exceeds a predetermined appropriate range, control information is sent to the thin film forming device (not illustrated) in order to correct the unevenness in the deposition amount of the spacer layer. Furthermore, in a case where the unevenness in the etching amount exceeds a predetermined appropriate range, the control section sends control information to the etching device (not illustrated) in order to correct unevenness in the etching amount. Due to this, deposition unevenness and/or etching unevenness are reduced during the subsequent spacer double patterning process (step 164A), which makes it possible to manufacture the repetitive pattern 17B with the pitch P/2 with high accuracy.

Here, in step 162A, the information about the unevenness in the etching amount and the unevenness in the deposition amount of the spacer layer for the entire surface of the wafer 10 may be directly supplied from the signal output section 90 to respective control sections of the thin film forming device (not illustrated) and the etching device (not illustrated) instead of the control section of the device manufacturing system. Furthermore, the information may be supplied to a host computer (not illustrated) of the device manufacturing system.

According to the present embodiment, the polarization state of the reflected light is inspected under the two apparatus conditions using the wafer 10d on which the repetitive pattern 17B for a device which will be an actual product is formed, which makes it possible to determine, with high accuracy, the etching amount used in the etching device when forming the pattern with the effect of the deposition amount of the spacer eliminated. In addition, it is possible to determine or estimate, with high accuracy, the deposition amount of the spacer in the thin film forming device with the effect of the etching amount eliminated.

As described above, the inspection apparatus 1 and the inspection method of the present embodiment are an apparatus and a method for determining the processing conditions of the non-planar repetitive pattern 17B provided on the wafer 10d by processing under a plurality of processing conditions including the deposition amount of the spacer layer and the etching amount of the spacer layer. Then, the inspection apparatus 1 is provided with the stage 5 capable of holding the wafer 10d which has the pattern 17B formed on the surface thereof, the illumination system 20 which illuminates the surface of the wafer 10d with the linearly polarized illumination light ILI (polarized light), the imaging device 35 and the image processing section 40 which receive light emitted from the surface of the wafer 10 and detect the Stokes parameters S1 to S3 (conditions for prescribing the polarization state) of the light, and the computing section 50 which determines the apparatus condition of the inspection apparatus 1 for determining the processing conditions of the inspection target pattern 17B formed on the surface of the inspection target wafer 10d on the basis of the Stokes parameters of the light emitted from the condition-parameterizing wafer having the pattern 17B formed thereon under known processing conditions. The inspection apparatus 1 determines the processing conditions of the pattern 17B on the basis of the Stokes parameters of the light emitted from the surface of the wafer 10d under the apparatus condition determined by the computing section 50.

Furthermore, the inspection method of the present embodiment includes steps 112B and 112C of illuminating the surface of the wafer 10d which has the pattern 17B formed on the surface thereof with polarized light and receiving the light emitted from the surface of the wafer 10d, steps 118B and 118C of detecting the Stokes parameters of the light, steps 132A and 134A of determining the apparatus condition (inspection condition) for determining the processing conditions of the inspection target pattern 17B formed on the surface of the inspection target wafer 10d on the basis of the Stokes parameters of the light emitted from the condition-parameterizing wafer which has the pattern 17B formed thereon under known exposure conditions, and steps 158A and 160A of determining the processing conditions of the pattern 17B on the basis of the Stokes parameters of the light emitted from the surface of the wafer 10d under the determined apparatus condition.

According to this embodiment, by using the wafer 10d having the non-planar repetitive pattern 17B provided by processing under a plurality of processing conditions, it is possible to estimate and determine, with high accuracy, each of the deposition amount of the spacer layer and the etching amount of the spacer layer out of the plurality of processing conditions with the effects of other processing conditions suppressed. Furthermore, it is not necessary to use a separate evaluation pattern and it is possible to determine the processing conditions by detecting light from the wafer on which the pattern for a device which will be an actual product is formed, which makes it possible to efficiently and highly accurately determine the processing conditions for the pattern to be practically formed.

Here, in the same manner as the first embodiment described above, in the present embodiment, the wafer may be illuminated with circularly polarized light. In such a case, for example, a half-wavelength plate in addition to the polarizer 26 is provided, and thus the light from the light source 22 is converted to circularly polarized light by the polarizer 26 and the half-wavelength plate and then illuminates the wafer. Furthermore, the wafer may also be illuminated with elliptically polarized light other than the circularly polarized light. Regarding the configuration for converting the light from the light source 22 to linearly polarized light or elliptically polarized light (elliptically polarized light including circularly polarized light), it is also possible to apply a known configuration other than the above configuration. Furthermore, it is also possible to use a light source which emits linearly polarized light or elliptically polarized light as the light source 22.

Here, in the same manner as the first embodiment described above, in the present embodiment, diffracted light from the surface of the wafer 10 may be received in the light-receiving system 30, and the exposure conditions may be evaluated on the basis of the calculated Stokes parameters. In such a case, the control section 80 controls the light-receiving system 30 on the basis of known diffraction conditions such that the light-receiving system 30 receives diffracted light from the surface of the wafer 10.

Here, in the same manner as the first embodiment described above, it is possible for the plurality of apparatus conditions in the present embodiment to include the rotation angle (the orientation of the transmission axis of the analyzer 32) of the analyzer 32, the rotation angle (orientation of the wafer) of the stage 5, and the like.

Here, in the same manner as the first embodiment described above, since there are four (S0 to S3) unknown numbers relating to the Stokes parameters, the angle of the quarter-wavelength plate 33 may be set to at least four different angles, and at least four images of the wafer 10d may be captured.

Here, the templates stored in the storage section 85 in step 132A and step 134A in the present embodiment are data in which the values of desired Stokes parameters corresponding to each of desired processing conditions are set into a table: however, the templates are not limited to being tables. For example, the templates may be curves (for example, refer to FIGS. 13E and 13F) or approximate expressions obtained by mathematically fitting the changes in desired Stokes parameters with respect to desired processing conditions using a desired function.

Here, in step 132A and step 134A in the present embodiment, the first apparatus condition (apparatus condition D) is determined on the basis of one type of Stokes parameter S2; however, for example, the apparatus condition may be determined on the basis of a plurality of types of Stokes parameters such as the Stokes parameters S2 and S3. In such a case, the plurality of types of Stokes parameters are calculated using a desired calculation formula (the second apparatus condition may also be calculated using a calculation formula in the same manner) such that the difference between the etching sensitivity and the deposition amount sensitivity of the plurality of types of target Stokes parameters is further increased. As the calculation formula of the plurality of types of Stokes parameters, it is possible to use various types of calculation formulas such as the sum and sum of squares. The exposure conditions are evaluated under the apparatus condition of the inspection apparatus 1 determined by using a desired calculation formula as described above, which makes it possible to evaluate the processing condition with higher accuracy compared to the method for determining the apparatus condition corresponding to one type of Stokes parameter.

Here, as the Stokes parameter to be used for determining the processing conditions, it is possible to use at least one desired parameter selected from Stokes parameters S1, S2, and S3.

Here, the processing conditions in the present embodiment may include a condition which is likely to be changed as a processing condition in the etching device and the thin film forming device in addition to the etching amount, the deposition amount of the spacer, and the like. For example, the condition may be the deposition amount of the hard mask layer 17 or the etching amount (slimming amount) when forming the line section 12A. Furthermore, the processing conditions of the etching device may include the etching time, the temperature, or the like in the etching device, and the processing conditions of the thin film forming device may include the deposition time of the thin film, the temperature, or the like in the thin film forming device. In addition, without being limited to the etching device or the thin film forming device, for example, the conditions may be processing conditions in a coater/developer which forms a resist on the wafer and develops the resist after exposure using the exposure device. In such a case, the processing conditions of the coater/developer may include the baking temperature of or the time for the resist applied on the wafer, or the time for developing the resist or the temperature of the developing liquid after exposure.

Here, in step 158A and step 160 of the present embodiment, the difference between the measured value tsx and the optimum value of the deposition amount of the spacer layer and the difference between the measured value tey and the optimum value of the etching amount need not be calculated. For example, various calculation methods may be used for the measured value tsx and the measured value tey calculated in step 158A and step 160A, the ratio of the measured value Dx with respect to the appropriate deposition amount of the spacer layer and the ratio of the measured value Fy with respect to the appropriate etching amount, and the like. Furthermore, the determination results of the exposure conditions need not be displayed on a display device (not illustrated).

### Third Embodiment

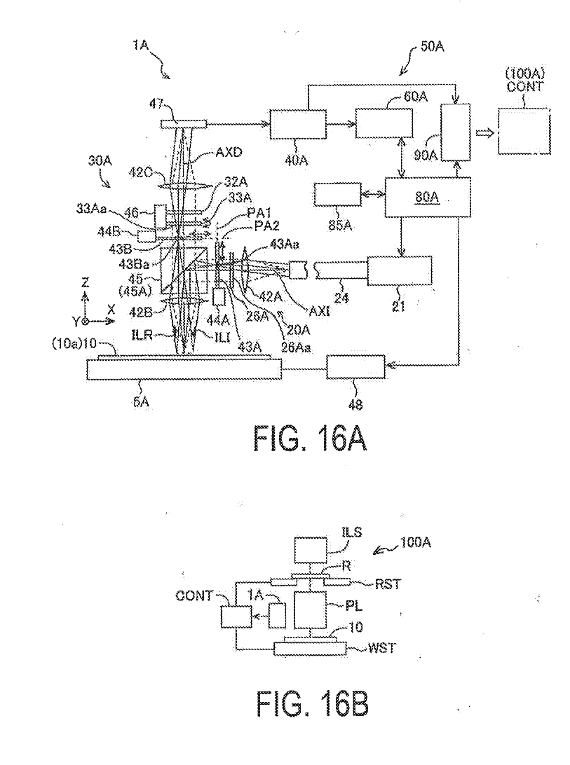

Description will be given of the third embodiment with reference to FIG. 16A to FIG. 18. In FIGS. 16A and 16B, the same reference numerals are given to the portions corresponding to FIG. 1A and detailed description thereof will be omitted. FIG. 16B illustrates an exposure device 100A according to the present embodiment. In FIG. 16B, as disclosed in, for example, US Patent Application Publication No. 2007/242247, the exposure device 100A is provided with an illumination system ILS which illuminates a reticle R with exposure light, a reticle stage RST which moves while holding the reticle R, a projection optical system PL which exposes the surface of the wafer 10 to a pattern of the reticle R, a wafer stage WST which moves while holding the wafer 10, a driving mechanism (not illustrated) for the stages RST and WST, a local liquid immersion mechanism (not illustrated) which supplies liquid between the projection optical system PL and the wafer 10 for liquid immersion exposure, and a main control device CONT which controls the operation of the apparatus as a whole. In addition, the exposure device 100A of the present embodiment is provided with an on-body inspection apparatus 1A for measuring the Stokes parameters of the light reflected from the pattern of the wafer 10 and determining exposure conditions of the pattern.

FIG. 16A illustrates the inspection apparatus 1A according to the present embodiment. In FIG. 16A, the inspection apparatus 1A is provided with a stage 5A which moves in at least two-dimensional directions (assumed to be directions along the X axis and the Y axis which are orthogonal to each other) while holding the wafer 10, a driving section 48 for the stage 5A, an illumination system 20A which illuminates a region (region to be inspected) which is a part of the surface (that is, the wafer surface) of the wafer 10 held on the stage 5A with illumination light ILI, a light-receiving system 30A which receives reflected light ILR from the wafer surface irradiated with the illumination light ILI and forms an image of the region to be inspected, a two-dimensional imaging element 47 which detects the image, an image processing section 40A which determines conditions for prescribing the polarization state by processing the image signal outputted from the imaging element 47, a computing section 50A which determines the exposure conditions (processing conditions) of a pattern on the wafer surface using the information about the conditions, and a control section 80A which controls the operation of the apparatus as a whole. The wafer stage WST serves as the stage 5A in the present embodiment. Here, in FIG. 16A, the Z axis is perpendicular to the plane including the X axis and the Y axis.

The illumination system 20A is provided with the illumination unit 21 which emits illumination light, the light guiding fiber 24 which guides illumination light emitted from the illumination unit 21, an illumination lens 42A which collimates the illumination light emitted from the light guiding fiber 24, a polarizer 26A which linearly polarizes the illumination light, an illumination-side aperture stop 43A which has an aperture 43Aa arranged on a surface PA1 approximately conjugate with a pupil surface (surface conjugate with the exit pupil of an objective lens 42B) of the light-receiving system 30A, a driving section 44A which two-dimensionally drives the aperture stop 43A in a plane orthogonal to an optical axis AXI of the illumination system 20A (in the YZ plane in FIG. 16A), a beam splitter 45 which directs a part of the illumination light passing through the aperture 43Aa to the wafer 10 side, and the objective lens 42B which condenses the illumination light reflected by the beam splitter 45 on the region to be inspected. Here, it is also possible to omit the polarizer 26A and to set the beam splitter 45 as a polarizing beam splitter 45A.

The light-receiving system 30A is provided with the objective lens 42B which receives light reflected from the region of the wafer 10 to be inspected, the beam splitter 45, a light receiving side aperture stop 43B which has an aperture 43Ba arranged on a surface PA2 approximately conjugate with the pupil surface (exit pupil of the objective lens 42B) of the light-receiving system 30A, a driving section 44B which two-dimensionally drives the light receiving side aperture stop 43B in a plane orthogonal to an optical axis AXD of the light-receiving system 30A (in the XY plane in FIG. 16A), a quarter-wavelength plate 33A which is arranged on the optical path of the light passing through the aperture 43Ba, an analyzer 32A which is arranged on the optical path of the light passing through the quarter-wavelength plate 33A, a driving section 46 which separately rotates the quarter-wavelength plate 33A and the analyzer 32A, and an image forming lens 42C which forms an image of a region of the wafer to be inspected on a light receiving surface of the imaging element 47 by condensing reflected light ILR passing through the analyzer 32A. As an example, the transmission axis of the polarizer 26A is set so that the illumination light ILI is P polarized light with respect to the incident surface of the illumination light ILI which is incident on the wafer 10. Furthermore, in order for the specularly reflected light ILR from the wafer 10 to be received by the light-receiving system 30A, the aperture 43Ba of the light receiving side aperture stop 43B is placed at a position (position through which light reflected from the region of the wafer 10 to be inspected passes due to the illumination light from the illumination unit 21 which passes through the aperture 43Aa of the illumination-side aperture stop 43A) symmetric with the aperture 43Aa of the illumination-side aperture stop 43A with respect to the optical axis. Here, it is also possible to use a variable shutter mechanism formed by a liquid crystal display element instead of the aperture plates 43A and 43B. Here, the driving section 46 separately rotates the quarter-wavelength plate 33A and the analyzer 32A around an axis (in other words, the optical axis AXD) parallel to the Z axis passing through the center of an incident surface 33Aa where a light beam is incident on the quarter-wavelength plate 33A. In addition, the inspection apparatus 1A is provided with a driving section (not illustrated) which rotates the polarizer 26A around an axis (in other words, the optical axis AXI) parallel to the X axis and passing through the center of an incident surface 26Aa where a light beam is incident on the polarizer 26A.

As an example, it is possible to set the orientation of the transmission axis of the analyzer 32A to a direction (that is, crossed Nicols) orthogonal to the orientation of the transmission axis of the polarizer 26A. Furthermore, it is possible to control the rotation angle of the quarter-wavelength plate 33A within a range of 360° using the driving section 46 on the basis of a command from control section 80A. By processing a plurality of images of the region of the wafer 10 to be inspected which are obtained while rotating the quarter-wavelength plate 33A, it is possible to determine the Stokes parameters which are conditions for prescribing the polarization state of the light reflected from the wafer 10, for example, for every pixel in the same manner as the first embodiment.

Furthermore, in the inspection apparatus 1A, by switching the wavelength of the illumination light ILI by the illumination unit 21, switching the incident angle (reflection angle) of the illumination light ILI with respect to the wafer 10 by driving the aperture plates 43A and 43B, and switching the rotation angle of the polarizer 26A, it is possible to select the optimum apparatus condition by switching the apparatus condition for measuring the Stokes parameters of the light reflected from the wafer 10. In addition, when measuring the Stokes parameters, the measurement of the distribution of the Stokes parameter of a region on the surface of the wafer 10 to be inspected and the movement of a separate region on the wafer 10 to be inspected to the illumination region of the illumination light ILI using the stage 5A are repeated, which makes it possible to measure the Stokes parameters of the light reflected from the pattern over the entire surface of the wafer 10 and to determine the exposure conditions when forming the pattern from the measurement results.

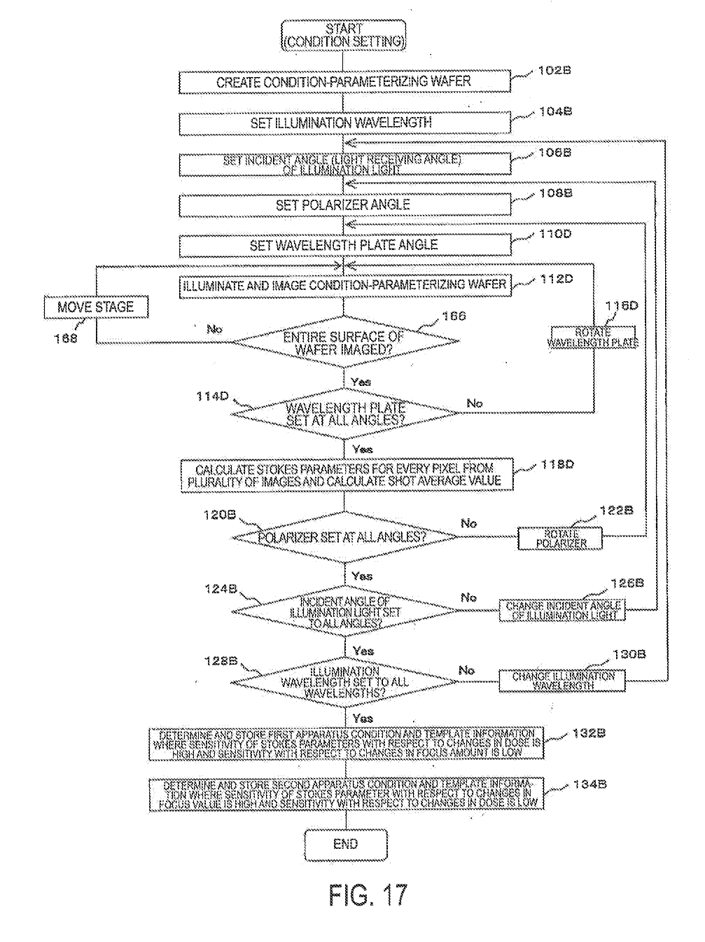

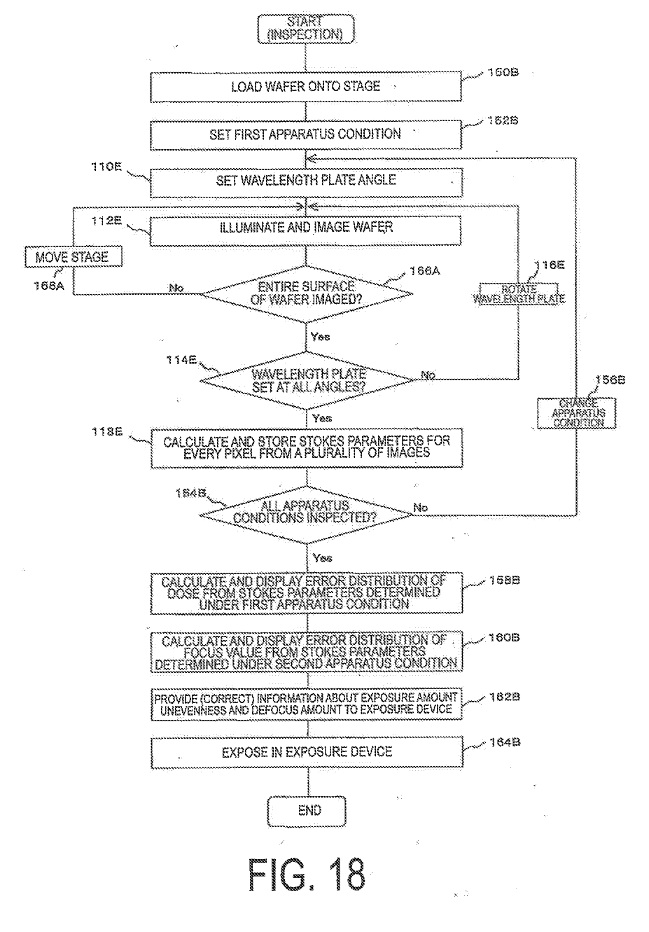

Next, in the present embodiment, with reference to the flow chart in FIG. 18, description will be given of an example of a method for determining the exposure conditions (here, assumed to be the exposure amount and the focus position) of the exposure device 100A used when forming the pattern by detecting the light from the repetitive pattern on the wafer surface using the inspection apparatus 1A. Furthermore, description will be given of an example of a method for determining the apparatus condition (inspection condition) prior to the determination with reference to the flow chart in FIG. 17. These operations are controlled by the control section 80A. Here, in FIG. 17 and FIG. 18, the similar reference numerals are given to the steps corresponding to the steps in FIG. 4 and FIG. 5 and description thereof will be omitted or simplified.

First, for the condition setting, in step 102B in FIG. 17, the condition-parameterizing wafer 10a formed by a so-called FEM wafer exposed and developed with the exposure amount and the focus position varying in a matrix form is created as illustrated in FIG. 1C. After being created, the condition-parameterizing wafer 10a is carried onto the stage 5A of the inspection apparatus 1A. Then, the control section 80A reads out a plurality of apparatus conditions from the recipe information stored in a storage section 85A. As an example, it is assumed that the wavelength λ of the illumination light ILI is any one of λ1, λ2, and λ3 described above, the incident angle (emission angle of light reflected from the wafer) of the illumination light ILI on the wafer is any one of 15°, 30°, 45°, and 60°, and the rotation angle of the polarizer 26A is set to a plurality of angles at intervals of, for example, approximately 5° centering on a crossed Nicols state in the plurality of apparatus conditions. Here, it is also possible to represent the apparatus conditions in which the wavelength λ is λn (n=1 to 3), the incident angle is αm (m=1 to 4), and the rotation angle of the polarizer 26 is βj (j=1 to J, J is an integer of two or more) as the conditions ∈ (n−m−j).

Then, in the inspection apparatus 1A, the wavelength of the illumination light ILI is set to λ1 (step 104B), the incident angle of the illumination light ILI is set to α1 by adjusting the position of the aperture 43Aa of the illumination-system aperture stop 43A (together with setting the light receiving angle of the light-receiving system 30A by adjusting the position of the aperture 43Ba of the light-receiving system aperture 43B) (step 106B), the rotation angle of the polarizer 26 is set to β1 (step 108B), and the rotation angle of the quarter-wavelength plate 33A (phase plate) is set to the initial value (step 110D). Then, under these apparatus conditions, the surface of the condition-parameterizing wafer 10a is irradiated with the illumination light ILI, and the imaging element 47 images the condition-parameterizing wafer 10a and outputs the image signal to the image processing section 40A (step 112D). Next, it is determined whether or not the entire surface of the wafer 10a has been imaged (step 166). When there is a portion which has not been imaged, the stage 5A is driven in the X direction or the Y direction in step 168 in order to move the portion of the surface of the wafer 10a which has not been imaged to the illumination region (observation region) of the illumination light ILI. Then, the flow returns to step 112D and the wafer 10a is imaged. Then, steps 168 and 112D are repeated until the entire surface of the wafer 10a has been imaged. After the entire surface of the wafer 10a has been imaged, the flow proceeds to step 114D, and it is determined whether or not the quarter-wavelength plate 33A has been set to all of the angles.

Then, in a case where the quarter-wavelength plate 33A has not been set to all of the angles, the quarter-wavelength plate 33A is rotated by, for example, 360°/256 (step 116D), and then the flow returns to step 112D and the condition-parameterizing wafer 10a is imaged. Repeating the steps 112D, 166, and 168 until the quarter-wavelength plate 33A has been rotated 360° in step 114D results in 256 images of the entire surface of the wafer corresponding to the different rotation angles of the quarter-wavelength plate 33A being captured.

Thereafter, the flow proceeds from step 114D to step 118D, and the image processing section 40A determines the Stokes parameters S0 to S3 for every pixel of the imaging element 47 from the obtained 256 digital images of the wafer using the rotating-retarder polarimetry described above. The Stokes parameters S0 to S3 are outputted to the first computing section of an inspection section 60A and, as an example, the average values of every shot of the Stokes parameters are determined in the first computing section and outputted to the second computing section and the storage section 85A.

Thereafter, it is determined whether or not the rotation angle of the polarizer 26A has been set to all of the angles (step 120B). In a case of not having been set to all of the angles, the rotation angle is set to an angle α2 by rotating the polarizer 26A, for example, 5° (or −5°) (step 122B), and the flow returns to step 110D. Then, the calculation of the Stokes parameters and the like are performed for every pixel of the image of the wafer surface using the rotating-retarder polarimetry (steps 1100D to 118D). Thereafter, in a case where the rotation angle of the polarizer 26A has been set to all of the angles βj (j=1 to J), the flow proceeds from step 120B to step 124B, and then it is determined whether or not the incident angle of the illumination light ILI has been set to all of the angles. In a case of not having been set to all of the angles, the aperture 43Aa of the illumination system aperture stop 43A is moved, the incident angle is set to α2 (step 126B), and then the flow returns to step 108B. Then, the calculation of the Stokes parameters and the like are performed for every pixel of the image of the wafer surface using the rotating-retarder polarimetry (steps 108B to 120B). Thereafter, in a case where the incident angle been set to all of the angles αm (m=1 to 4), the flow proceeds from step 124B to step 128B, and then it is determined whether or not the wavelength λ of the illumination light ILI has been set to all of the wavelengths. In a case of not having been set to all of the wavelengths, the wavelength λ is changed to λ2 by the illumination unit 21 (step 130B), and the flow returns to step 106B. Then, the calculation of the Stokes parameters and the like are performed for every pixel of the image of the wafer surface using the rotating-retarder polarimetry (steps 106B to 124B). Thereafter, in a case where the wavelength λ has been set to all of the wavelengths λn (n=1 to 3), the flow proceeds from step 128B to step 132B.

Furthermore, as described in the first embodiment, when the exposure amount changes, the Stokes parameters S1, S2, and S3 of the reflected light change, and when the focus position changes, the Stokes parameters S1 and S3 of the reflected light change comparatively greatly while the Stokes parameter S2 hardly changes. For this reason, in the present embodiment, as an example, the exposure amount is determined using the Stokes parameters S2 and/or S3, and the focus position is determined using the Stokes parameter S3.

Then, using the shot average values of the Stokes parameters measured under all of the apparatus conditions described above, the first apparatus condition under which the dose sensitivity of the Stokes parameters S2 and S3 is high and the focus sensitivity is low is determined in the second computing section of the inspection section 60A, and the first apparatus condition and data in which the values of the Stokes parameters S2 and S3 corresponding to the respective exposure amounts obtained under the apparatus condition are set into a table are stored in the storage section 85 as a template (step 132B).

In addition, the second apparatus condition under which the focus sensitivity of the Stokes parameter S3 is high and the dose sensitivity is low is determined in the second computing section, and the second apparatus condition and data in which the values of the Stokes parameter S3 corresponding to the respective focus values obtained under the apparatus condition are set into a table are stored in the storage section 85 as a template (step 134B).

At this time, as an example, the first apparatus condition under which the dose sensitivity of the Stokes parameter S2 is high and the focus sensitivity is low is the apparatus condition A corresponding to the curve BS21 in FIG. 10A and the curve CS21 in FIG. 10B. Furthermore, the first apparatus condition under which the dose sensitivity of the Stokes parameter S3 is high and the focus sensitivity is low is the apparatus condition B corresponding to the curve BS32 in FIG. 10C and the curve CS32 in FIG. 10D. Furthermore, the second apparatus condition under which the focus sensitivity of the Stokes parameter S3 is high and the dose sensitivity is low is the apparatus condition A corresponding to the curve CS31 in FIG. 10D and the curve BS31 in FIG. 10C.

Accordingly, the data in which the values of the Stokes parameter S2 corresponding to the respective exposure amounts obtained under the first apparatus condition (here, apparatus condition A) are set into a table is stored in the storage section 85A as the template TD1 (table based on the curve BS21 representing changes in the Stokes parameter S2 with respect to the exposure amount). Similarly, the data in which the values of the Stokes parameter S3 corresponding to the respective exposure amounts obtained under the first apparatus condition (here, apparatus condition B) are set into a table is stored in the storage section 85 as the template TD2. Furthermore, the data in which the values of the Stokes parameter S3 corresponding to the respective focus values obtained under the second apparatus condition (here, apparatus condition A) are set into a table is stored in the storage section 85A as the template TF1. Here, FIGS. 11A and 11B show appropriate ranges 50D and 50F (non-defective ranges) of the exposure amount and the focus value. Accordingly, in the present embodiment, the apparatus condition (inspection condition) includes the first apparatus condition (apparatus conditions A and B) and the second apparatus condition (apparatus condition B) different from the first apparatus condition.

The condition setting for obtaining the first and second apparatus conditions to be used for determining the wafer exposure condition is completed through the operations described above.

Next, with respect to the wafer on which the repetitive pattern is formed by exposure using the exposure device 100 in the practical device manufacturing process, the exposure amount and the focus position in the exposure conditions of the exposure device 100 are determined as follows by measuring the Stokes parameters of the light reflected from the wafer surface using the two apparatus conditions obtained by the inspection apparatus 1A in the condition setting described above. As illustrated in FIG. 18, first, the wafer 10, which has the same shot arrangement as in FIG. 6A and which will be an actual product on which a resist is applied, is carried to the exposure device 100A, each of the shots SAn (n=1 to N) of wafer 10 is exposed to a pattern of a reticle (not illustrated) for the practical product by the exposure device 100, and the wafer 10 is developed after being exposed. At this time, the exposure conditions are set so that the exposure amount is an appropriate exposure amount determined according to the reticle and the focus position is an appropriate focus position.

Then, in step 150B in FIG. 18, the exposed and developed wafer 10 is loaded onto the stage 5A (here, the wafer stage WST) of the inspection apparatus 1A in FIG. 16 via an alignment mechanism (not illustrated). Then, the control section 80A reads out the first and second apparatus conditions determined in the condition setting described above from the recipe information stored in the storage section 85A. Then, the apparatus condition is set to the first apparatus condition (of which, the apparatus condition A for the Stokes parameter S2 here) where the dose sensitivity of the Stokes parameters S2 and S3 is high (step 152B), and the rotation angle of the quarter-wavelength plate 33A is set to the initial value (step 110E). Then, the wafer surface is irradiated with the illumination light ILI, and the imaging element 47 outputs the image signal of the wafer surface to the image processing section 40A (step 112E).

Next, it is determined whether or not the entire surface of the wafer 10 has been imaged (step 166A). When there is a portion which has not been imaged, the stage 5 is driven in the X direction or the Y direction in step 168A in order to move the portion of the surface of the wafer 10 which has not been imaged to the illumination region (observation region) of the illumination light ILI. Then, the flow returns to step 112E and the wafer 10 is imaged. Then, steps 168A and 112E are repeated until the entire surface of the wafer 10 has been imaged. After the entire surface of the wafer 10 has been imaged, the flow proceeds to step 114E, and it is determined whether or not the quarter-wavelength plate 33A has been set to all of the angles. In a case where the quarter-wavelength plate 33A has not been set to all of the angles, the quarter-wavelength plate 33A is rotated by, for example, 360°/256 (step 116E), and then the flow proceeds to step 112E and the wafer 10 is imaged. Repeating the steps 112E, 166A, and 168A until the quarter-wavelength plate 33A has been rotated 360° in step 114E results in 256 images of the entire surface of the wafer corresponding to the different rotation angles of the quarter-wavelength plate 33A being captured.

Thereafter, the flow proceeds to step 11E and the image processing section 40A determines the Stokes parameters S2 and S3 for every pixel of the imaging element 47 from the obtained 256 digital images of the wafer using the rotating-retarder polarimetry described above. The Stokes parameters are outputted to the first computing section of the inspection section 60A, and the average values of every shot of the Stokes parameters (that is, the shot average values) are determined and outputted to the third computing section and the storage section 85A. Then, it is determined whether or not all of the apparatus conditions are determined (step 154B). In a case where all of the apparatus conditions for inspection have not been set, another apparatus condition is set in step 156B and then the flow proceeds to step 110E.

In the present embodiment, since the first apparatus condition with respect to the Stokes parameter S3 is the apparatus condition B, here, the apparatus condition B is set. Thereafter, steps 110E to 118E are repeated, and then the shot average values of the Stokes parameters (here, S3) are determined under the apparatus condition B and stored. Furthermore, since the second apparatus condition is the same as the apparatus condition A here, the Stokes parameter S3 determined when the apparatus condition A is set is used as the Stokes parameter determined under the second apparatus condition. Here, typically, there is a possibility that steps 110E to 118E will be executed in a state where another apparatus condition is set as the second apparatus condition. Then, when it is determined in step 154 that the determinations under the first and second apparatus conditions have been completed, the operation proceeds to step 158B.

Then, in step 158B, the third computing section of the inspection section 60A collates values (assumed to be S2x and S3x) of the Stokes parameters S2 and S3 for every pixel determined under the first apparatus condition with the templates TD1 and TD2 stored in step 132B described above to determine exposure amounts Dx1 and Dx2. Here, in practice, the exposure amounts Dx1 and Dx2 are approximately the same values. Furthermore, as an example, the average values of the exposure amounts Dx1 and Dx2 may be set as a measurement value Dx of the exposure amount. The distribution of the difference (error) of the measurement value Dx from the optimum exposure amount Dbe is supplied to the control section 80A and further displayed on a display device (not illustrated) as necessary.

In addition, in step 160B, the third computing section of the inspection section 60A collates a value (assumed to be S3y) of the Stokes parameter S3 for every pixel determined under the second apparatus condition with the template TF1 in FIG. 11B stored in step 134B to determine a focus values Fy. The distribution of the difference (error) of the measurement value Fy from the optimum focus position Zbe is supplied to the control section 80 and further displayed on a display device (not illustrated) as necessary.

Thereafter, information about the error distribution of the exposure amount (exposure amount unevenness) for the entire surface of the wafer 10 and the error distribution of the focus position (defocus amount distribution) is provided from the signal output section 90A to the main control device CONT of the exposure device 100A under the control of the control section 80A (step 162B). Accordingly, for example, in order to correct the exposure conditions of the exposure amount and/or the focus position in a case where, for example, the exposure amount unevenness and/or the defocus amount distribution each exceed a predetermined appropriate range, correction of the distribution of the width of the illumination region in the scanning direction during scanning and exposure, or the like is performed in the main control device CONT of the exposure device 100A, for example. Due to this, the errors in the exposure amount distribution and defocus amount are reduced during subsequent exposure. Thereafter, the wafer is exposed under the corrected exposure condition in the exposure device 100A in step 164B.

According to this embodiment, the determination using the Stokes parameters under the two apparatus conditions by using the wafer 10 on which a pattern for a device which will be an actual product is performed, which makes it possible to estimate and determine, with high accuracy, the exposure amount and focus position in the exposure conditions of the exposure device 100A used when forming the pattern with both effects of the exposure amount and focus position eliminated.

As described above, the inspection apparatus 1A and the inspection method of the present embodiment are an apparatus and method for determining the exposure conditions of the non-planar repetitive pattern 12 provided on the wafer 10 by carrying out exposure under a plurality of exposure conditions including the exposure amount and the focus position. Then, the inspection apparatus 1A is provided with the stage 5A capable of holding the wafer 10 which has the pattern 12 formed on the surface thereof, the illumination system 20A which illuminates the surface of the wafer 10 with the linearly polarized illumination light ILI (polarized light), the imaging element 47 and the image processing section 40A which receive light emitted from the surface of the wafer 10 and detect the Stokes parameters S1 to S3 (conditions for prescribing the polarization state) of the light, and a computing section 50A which determines the apparatus condition of the inspection apparatus 1A for determining the exposure conditions of the inspection target pattern formed on the surface of the inspection target wafer 10 on the basis of the Stokes parameters of the light emitted from the condition-parameterizing wafer 10a which has a pattern formed thereon under known exposure conditions. The exposure conditions of the pattern are determined on the basis of the Stokes parameters of the light emitted from the surface of the wafer 10 under the apparatus condition determined by the computing section 50A.

Furthermore, the inspection method of the present embodiment includes steps 112D and 112E of illuminating the surface of the wafer 10 on which has the pattern 12 formed on the surface thereof with polarized light and receiving the light emitted from the surface of the wafer 10, steps 118D and 118E of detecting the Stokes parameters of the light, steps 132B and 134B of determining the apparatus condition (inspection condition) for determining the exposure conditions of the inspection target pattern 12 formed on the surface of the inspection target wafer 10 on the basis of the Stokes parameters of the light emitted from the condition-parameterizing wafer 10a which has the pattern 12 formed thereon under known exposure conditions, and steps 158B and 160B of determining the exposure conditions of the pattern 12 on the basis of the Stokes parameters of the light emitted from the surface of the wafer 10 under the determined apparatus condition.

According to this embodiment, by using the wafer 10 having the non-planar repetitive pattern 12 provided by exposure under a plurality of exposure conditions as a plurality of processing conditions, it is possible to estimate and determine, with high accuracy, each of the exposure amount and focus position out of the plurality of exposure conditions with the effects of other exposure conditions suppressed. Furthermore, it is not necessary to use a separate evaluation pattern, and it is possible to determine the exposure conditions by detecting light from the wafer on which the pattern for a device which will be an actual product is formed, which makes it possible to efficiently and highly accurately determine the exposure conditions for the pattern used for actual exposure.

Furthermore, in the present embodiment, the first and second apparatus conditions to be used during the inspection of the exposure conditions are conditions in which changes in the Stokes parameters S2 and S3 of the light emitted from the condition-parameterizing wafer 10a on which the pattern is formed under the exposure condition combining the known first and second exposure conditions (the exposure amount and the focus position) are greater than in a case where other exposure conditions change with respect to the change (sensitivity) in each of the first and second exposure conditions. Accordingly, it is possible to determine the first and second exposure conditions with the effects of other exposure conditions further suppressed.

Furthermore, the exposure system of the present embodiment is provided with the exposure device 100A (exposure section) having a projection optical system for exposing a wafer surface to a pattern, and the inspection apparatus 1A of the present embodiment. In such an exposure system, the exposure conditions in the exposure device 100A are corrected according to the first and second exposure conditions determined by the computing section 50A of the inspection apparatus 1A.

Furthermore, the exposure method of the present embodiment determines the first and second exposure conditions of the wafer using the inspection method of the present embodiment (steps 150B to 160B), and corrects the exposure conditions during exposure of the wafer according to the first and second exposure conditions estimated by the inspection method (step 162B).

As a result, the exposure conditions in the exposure device 100A are corrected according to the first and second exposure conditions estimated by the inspection apparatus 1A or the inspection method using the inspection apparatus 1A, which makes it possible to efficiently and highly accurately set the exposure conditions in the exposure device 100A to a desired state using the wafer to be used for manufacturing an actual device.

Here, the exposure device 100A illustrated in FIG. 16B in the present embodiment is provided with the on-body inspection apparatus 1A. The stage of the inspection apparatus 1A is also used as the wafer stage WST in the present embodiment; however, the exposure device 100A and inspection apparatus 1A may be separate. In such a case, as illustrated in FIG. 16A, the inspection apparatus 1A is provided with the stage 5A which holds the wafer 10. It is possible to rotate the stage 5A around the normal line (line parallel to the Z axis in FIG. 16A and line passing through the center of the upper surface of the stage 5A) in the center of the upper surface of the stage 5A and to move the stage 5A in two-dimensional directions (assumed to be directions along the X axis and the Y axis which are orthogonal to each other). Furthermore, the stage 5A is rotated and moved in two-dimensional directions by the driving section 48 provided in the inspection apparatus 1A.

Here, in the same manner as the first embodiment described above, in the present embodiment, the wafer may be illuminated with circularly polarized light or may be illuminated with elliptically polarized light other than circularly polarized light. Furthermore, it is also possible to use a light source which emits linearly polarized light or elliptically polarized light.

Here, in the same manner as the first embodiment described above, in the present embodiment, diffracted light from the surface of the wafer 10 may be received in the light-receiving system 30A, and the exposure conditions may be evaluated on the basis of the calculated Stokes parameters. In such a case, the control section 80A controls the light-receiving system 30A on the basis of known diffraction conditions such that the light-receiving system 30A receives diffracted light from the surface of the wafer 10.

Here, in the present embodiment, the quarter-wavelength plate 33A is arranged on the optical path of the light-receiving system 30A; however, the present embodiment is not limited to this arrangement. For example, the quarter-wavelength plate 33A may be arranged on the optical path of the illumination system 20A. Specifically, in the illumination system 20, the quarter-wavelength plate 33A may be arranged on the optical path of the light passing from the light guiding fiber 24A through the polarizer 26A.

Here, in the same manner as the first embodiment described above, it is possible for the plurality of apparatus conditions in the present embodiment to include the rotation angle (the orientation of the transmission axis of the analyzer 32A) of the analyzer 32A, the rotation angle (orientation of the wafer) of the stage 5A, and the like.

Here, in the same manner as the first embodiment described above, in the condition setting in FIG. 17 of the present embodiment, the exposure conditions (exposure amount and focus position) of the exposure device 100A used in the condition setting are determined using the templates TD1, TD2, and TF1 determined using the condition-parameterizing wafer 10a on which the repetitive pattern is formed by the exposure device 100A; however, the exposure conditions of a device different from the exposure device 100A may be determined using the templates TD1, TD2, and TF1.

Here, in the same manner as the first embodiment described above, in the present embodiment, for example, the Stokes parameters S1 and S2 may be used in the evaluation of the exposure amount and the Stokes parameters S1 and S3 may be used in the evaluation of the focus position. Furthermore, in the evaluation of the exposure amount, since the Stokes parameter S1 changes corresponding to changes in both of the exposure amount and the focus position, the determination of the exposure amount may be performed using the Stokes parameter S1 (or at least one parameter selected from S1, S2, and S3), and the determination of the focus position may be performed using the Stokes parameter S1 (or at least one parameter selected from S1, and S3). Furthermore, in such a case where changes in the elliptically polarized light from the wafer surface with respect to changes in each of the exposure amount and the focus position are not the changes illustrated in FIGS. 3A and 3B, the type of the Stokes parameter may be selected as appropriate so as to determine the first apparatus condition and the second apparatus condition on the basis of changes in the Stokes parameters with respect to changes in the exposure amount and changes in the Stokes parameters with respect to changes in the focus position.

Here, in the same manner as the first embodiment described above, since there are four (S0 to S3) unknown numbers relating to the Stokes parameters, the angle of the quarter-wavelength plate 33A may be set to at least four different angles, and at least four images of the wafer may be captured.

Here, the templates stored in the storage section 85 in step 132A and step 134A in the present embodiment are data in which the values of desired Stokes parameters corresponding to each of desired processing conditions are set into a table; however, the templates are not limited to being tables. For example, the templates may be curves (for example, refer to FIGS. 13E and 13F) or approximate expressions obtained by mathematically fitting the changes in desired Stokes parameters with respect to desired processing conditions using a desired function.

Here, in the same manner as the first embodiment described above, in the present embodiment, for example, the signal output section 90A may output the inspection results of the exposure conditions to a host computer (not illustrated) carrying out overall control of the operations of a plurality of exposure devices, and the like. In such a case, in step 162B in FIG. 18, information about the error distribution of the exposure amount (exposure amount unevenness) for the entire surface of the wafer 10 and the error distribution of the focus position (defocus amount distribution) may be provided from the signal output section 90A to a host computer (not illustrated). Then, on the basis of the information thus provided, the host computer (not illustrated) may send a command for correcting the exposure conditions (at least one of the exposure amount and focus position) to the exposure device 100A or to a plurality of exposure devices including the exposure device 100A.

Here, in the same manner as the first embodiment described above, in the present embodiment, the templates stored in the storage section 85A in step 132B and step 134B may be curves or approximate expressions obtained by mathematically fitting the values of desired Stokes parameters with respect to desired exposure conditions using a desired function. For example, in FIGS. 11A and 11B, the curves BS21 and BS32 showing changes in the Stokes parameters S2 and S3 with respect to the exposure amount obtained under the first apparatus condition (here, the apparatus conditions A and B) may be set as templates TD1 and TD2, or respective approximate expressions for the curves BS21 and BS32 may be set as the templates TD1 and TD2. In the same manner, the curve CS 32 obtained under the second apparatus condition (here, the apparatus condition A) may be set as the template TF1, or an approximate expression for the curve CS32 may be set as the template TF1.

Here, in the same manner as first embodiment described above, in step 158B and step 160B of the present embodiment, for example, various calculation methods may be used for the measured value Dx and the measured value Fy calculated in step 158B and step 160B, the ratio of the measured value Dx with respect to the optimum exposure amount Dbe, the ratio of the measured value Fy with respect to the optimum focus position Zbe, or the like. Furthermore, the inspection results of the exposure conditions need not be displayed on a display device (not illustrated).

Here, in the same manner as the first embodiment described above, in the present embodiment, for example, the Stokes parameters S2 and S3 may be calculated with a desired calculation formula such that the difference between the focus sensitivity and the dose sensitivity of the target Stokes parameter is further increased. It is possible to use various calculation formulas for the calculation formulas of the Stokes parameters S2 and S3, and, for example, calculation formulas such as [S2+S3](sum), [S2²+S3²](sum of squares), and the like may be used. The exposure conditions are evaluated under the apparatus condition of the inspection apparatus 1 determined by using a desired calculation formula as described above, which makes it possible to evaluate the exposure conditions with higher accuracy compared to the method for determining the two apparatus conditions separately for the Stokes parameters S2 and S3.

Here, in step 118D of the present embodiment, the Stokes parameters S0 to S3 are calculated; however, since the Stokes parameter S0 represents the total intensity of the light flux, only the Stokes parameters S1 to S3 need to be determined in order to determine the exposure conditions. Furthermore, in the present embodiment, when the exposure amount changes, the Stokes parameters S1, S2, and S3 of the reflected light change, and when the focus position changes, the Stokes parameters S1 and S3 of the reflected light change comparatively greatly while the Stokes parameter S2 hardly changes (refer to FIGS. 3A and 3B). For this reason, since it is possible to separately determine the conditions of the exposure amount and the focus position from only the Stokes parameters S2 and S3, only the Stokes parameters S2 and S3 need to be determined.

Here, in the same manner as the first embodiment described above, in the present embodiment, the Stokes parameters of pixels corresponding to the insides of all of the shots SAn (refer to FIG. 6B) excluding the scribe line regions SL of the condition-parameterizing wafer 10a may be calculated, and the calculated results may be averaged. This is because calculating the shot average values in this manner suppresses the effects of aberration or the like in the projection optical system PL of the exposure device 100A. Here, in order to further suppress the effects of the aberration or the like, for example, a value obtained by averaging the Stokes parameters of pixels corresponding to the inside of a partial region CAn located in the center portion of the shot SAn in FIG. 6B may be calculated.

In addition, in the embodiment described above, the exposure amount and the focus position are determined as the exposure conditions; however, the determination in the embodiment described above may be used in order to determine the wavelength of the exposure light in the exposure device 100A, the illumination conditions (for example, coherence factor (σ value)), the numerical aperture of the projection optical system PL, the temperature of the liquid during liquid immersion exposure, or the like as the exposure conditions.

Here, in the embodiment described above, conditions for prescribing the polarization state are represented by Stokes parameters. However, the conditions for prescribing the polarization state may be represented by Jones vectors formed of two rows of complex column vectors for representing the polarization characteristics of the optical system with so-called Jones notation. Jones notation is, for example, for representing the polarization characteristics of an optical system as described in Non-Patent Literature (M. Totzeck, P. Graeupner, T. Heil, A. Goehnermeier, O. Dittmann, D. S. Kraehmer, V. Kamenov, and D. G. Flagello: Proc. SPIE 5754, 23 (2005)), describing a Jones matrix formed of a complex matrix (polarization matrix) of 2 rows×2 columns and Jones vectors for representing the polarization state converted by the optical system.

Furthermore, the conditions for prescribing the polarization state may be represented using both the Stokes parameter and the Jones vectors. In addition, it is also possible to represent the conditions for prescribing the polarization state using a so-called Mueller matrix.

In addition, although the aforementioned embodiments describe the exposure device 100 and 100A as scanning steppers that use a liquid immersion exposure method, the same effects as described above can be achieved by applying the aforementioned embodiments even in the case where an exposure device such as a dry-type scanning stepper or stepper is used as the exposure device. Furthermore, the aforementioned embodiments can also be applied in the case where an EUV exposure device that uses EUV light (extreme ultraviolet light) having a wavelength of less than 100 nm as the exposure light, an electron beam exposure device that uses an electron beam as an exposure beam is used as the exposure device.

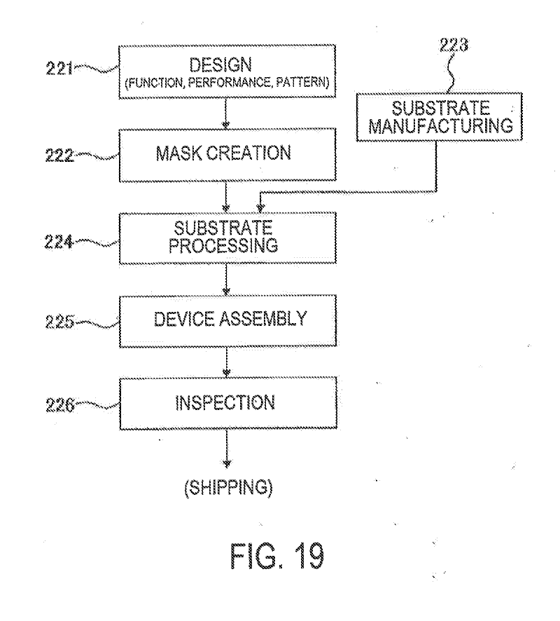

Meanwhile, as illustrated in FIG. 19, a semiconductor device (not illustrated) is manufactured through the following: a design process of designing functions and performance of the device (step 221); a mask manufacturing process of manufacturing a mask (a reticle) on the basis of the design process (step 222); a substrate manufacturing process of manufacturing a substrate for a wafer from a silicon material or the like (step 223); a substrate processing process of forming a pattern on the wafer using the device manufacturing system DMS or a pattern forming method that uses that system (step 224); an assembly process, including a dicing process, a bonding process, a packaging process, and so on, for assembling the device (step 225); an inspection process of inspecting the device (step 226); and so on. In the substrate processing step (step 224), a lithography step including a step of applying a resist onto a wafer, an exposure step of exposing the wafer to a pattern of a reticle using the exposure devices 100 and 100A, and a developing step of developing the wafer, and an inspection step of inspecting the exposure conditions and the like using light from the wafer using the inspection apparatuses 1 and 1A are executed.

In such a device manufacturing method, the exposure conditions and the like are inspected using the inspection apparatuses 1 and 1A described above and, the exposure conditions and the like are corrected on the basis of, for example, the inspection results, which makes it possible to improve the yield of the semiconductors to be finally manufactured.

Although the device manufacturing method according to the present embodiment describes a method for manufacturing a semiconductor device in particular, the device manufacturing method of the present embodiment can also be applied in, for example, the manufacture of devices that use materials aside from semiconductor materials, such as liquid crystal panels, magnetic disks, and the like, in addition to devices that use semiconductor materials.

Here, it is possible to combine the conditions of each of the embodiments described above as appropriate. Furthermore, there may be cases where some of the constituent components are not used. Furthermore, the disclosures of all of the published patents and US patents relating to the inspection apparatus, inspection method and the like cited in each of the embodiments and modifications described above are incorporated as a part hereof by reference to the extent permitted by law.

1. An inspection apparatus configured to determine a processing condition for a pattern, the apparatus comprising:
a stage configured to hold a substrate having a pattern formed on a surface thereof;
an illuminator configured to illuminate the surface of the substrate with polarized light;
a detector configured to receive light emitted from the surface of the substrate and detect a condition for prescribing a polarization state of the light;
a storage configured to store an apparatus condition for determining the processing condition of an inspection target pattern formed on a surface of an inspection target substrate based on a condition for prescribing the polarization state of light emitted from a substrate having a pattern formed thereon under the known processing condition; and
an inspector configured to determine the processing condition of the inspection target pattern on the basis of a condition for prescribing the polarization state of light emitted from the surface of the inspection target substrate under the apparatus condition.

2. The inspection apparatus according to claim 1, wherein
the condition for prescribing the polarization state includes a first prescribing condition and a second prescribing condition, and
the apparatus condition includes a first apparatus condition based on the first prescribing condition and a second apparatus condition based on the second prescribing condition.

3. The inspection apparatus according to claim 2, wherein
the processing condition includes a first processing condition and a second processing condition, and the inspector determines the first processing condition of the inspection target pattern on the basis of the first prescribing condition of light emitted from the surface of the inspection target substrate under the first apparatus condition, and determines the second processing condition of the inspection target pattern on the basis of the second prescribing condition of light emitted from the surface of the inspection target substrate under the second apparatus condition.

4. The inspection apparatus according to claim 1, wherein
the condition for prescribing the polarization state includes a first prescribing condition and a second prescribing condition, the apparatus condition is based on a result calculated with a calculation formula using the first prescribing condition and the second prescribing condition of the light emitted from the substrate having the pattern formed thereon using the known processing condition, and
the inspector determines the processing condition of the inspection target pattern on the basis of the result calculated with the calculation formula using the detected first prescribing condition and second prescribing condition.

5. The inspection apparatus according to claim 1, wherein
the processing condition is a condition in which a change in the condition for prescribing the polarization state of light emitted from the substrate having a pattern formed under a processing condition combining the known first processing condition and the known second processing condition is greater than in a case where another processing condition changes with respect to changes in the first processing condition and the second processing condition.

6. The inspection apparatus according to claim 1, wherein
the inspector determines the inspection condition on the basis of a condition for prescribing a polarization state of light detected from light emitted from the surface of the substrate after the substrate having the pattern formed on the surface thereof under the known processing condition being illuminated with polarized light.

7. The inspection apparatus according to claim 1, wherein
the detector detects at least one of Stokes parameters and Jones vectors as the condition for prescribing the polarization state of the light.

8. The inspection apparatus according to claim 1, wherein
the apparatus condition include at least one of an illumination condition for the illumination unit, a detection condition for the detector, and a posture condition for the stage.

9. The inspection apparatus according to claim 8, wherein
the illumination condition include at least one of an incident angle of polarized light incident on the surface of the substrate, a wavelength of polarized light incident on the surface of the substrate, and a polarization direction of polarized light incident on the surface of the substrate.

10. The inspection apparatus according to claim 8, wherein
the detection condition include at least one of a light receiving angle of light emitted from the surface of the substrate to be received by the detector, and a polarization direction of light emitted from the surface of the substrate to be received by the detector.

11. The inspection apparatus according to claim 8, wherein
the posture condition include at least one of an orientation of a repetitive direction of the pattern formed on the substrate held on the stage, and an inclination angle of the stage.

12. The inspection apparatus according to claim 1, wherein
the illumination unit irradiates the surface of the substrate with linearly polarized light.

13. The inspection apparatus according to claim 1, wherein
the detector receives light specularly reflected from the surface of the substrate and detects the condition for prescribing the polarization state of the light.

14. The inspection apparatus according to claim 1, wherein
the inspection target pattern formed on the surface of the inspection target substrate is formed through a lithography process including exposure by an exposure device, and
the processing condition determined by the inspection apparatus include at least one of an exposure amount of the exposure and a focus state in the exposure device.

15. The inspection apparatus according to claim 1, wherein
the illumination unit illuminates an entire surface of the substrate with the polarized light at once, and the detector includes an imaging element which images the entire surface of the substrate.

16. The inspection apparatus according to claim 1, wherein
the illumination unit illuminates a part of the surface of the substrate with the polarized light,
the detector includes an imaging element which images the part of the surface of the substrate, and the stage is capable of moving the substrate such that the entire surface of the substrate is sequentially irradiated with the polarized light from the illumination unit.

17. The inspection apparatus according to claim 1, wherein
the inspector determines the apparatus condition of the inspection apparatus for determining a shape resulting from the processing condition of the inspection target pattern formed on the surface of the inspection target substrate on the basis of the condition for prescribing the polarization state of the light emitted from the substrate having the pattern formed thereon under the known processing condition, and determines the shape resulting from the processing condition of the inspection target pattern on the basis of the condition for prescribing the polarization state of the light emitted from the surface of the inspection target substrate under the apparatus condition.

18. An exposure system comprising:
an exposure section including a projection optical system which exposes a surface of a substrate to a pattern;
the inspection apparatus described in claim 1; and
a control section which corrects a processing condition in the exposure section according to the processing condition determined by the inspection apparatus.

19. An inspection method for determining a processing condition of an inspection target pattern, the method comprising:
illuminating a surface of an inspection target substrate having an inspection target pattern formed thereon with polarized light under an inspection condition based on a condition for prescribing a polarization state of light emitted from a substrate having a pattern formed thereon under the known processing condition;
receiving light emitted from the surface of the inspection target substrate under the inspection condition and detecting the condition for prescribing the polarization state of the light; and
determining the processing condition of the inspection target pattern on the basis of the condition for prescribing the detected polarization state.

20. The inspection method according to claim 19, wherein
the condition for prescribing the polarization state includes a first prescribing condition and a second prescribing condition, and
the inspection condition include a first inspection condition based on the first prescribing condition and a second inspection condition based on the second prescribing condition.

21. The inspection method according to claim 20, wherein
the processing condition includes a first processing condition and a second processing condition, and the determining determines the first processing condition of the inspection target pattern on the basis of the first prescribing condition of the light emitted from the surface of the inspection target substrate under the first inspection condition and determines the second processing condition of the inspection target pattern on the basis of the second prescribing condition of the light emitted from the surface of the inspection target substrate under the second inspection condition.

22. The inspection method according to claim 19, wherein
the condition for prescribing the polarization state include a first prescribing condition and a second prescribing condition,
the inspection condition is based on a result calculated with a calculation formula using the first prescribing condition and the second prescribing condition of the light emitted from the substrate having the pattern formed thereon under the known processing condition, and
the determining includes determining the processing condition of the inspection target pattern on the basis of the result calculated with the calculation formula using the detected first prescribing condition and the second prescribing condition.

23. The inspection method according to claim 19, wherein
the processing condition include the first processing condition and the second processing condition,
the inspection condition is a condition in which a change in the condition for prescribing the polarization state of light emitted from the substrate having a pattern formed thereon under a processing condition combining the known first processing condition and the known second processing condition is greater than in a case where another processing condition changes with respect to a change in each of the first processing condition and the second processing condition.

24. The inspection method according to claim 19, further comprising:
determining the inspection condition on the basis of the condition for prescribing the polarization state of the light detected from the light emitted from the surface of the substrate after the substrate having the pattern formed on the surface thereof under the known processing condition being illuminated with polarized light.

25. The inspection method according to claim 19, wherein
the detecting of the condition for prescribing the polarization state of the light includes detecting at least one of Stokes parameters and Jones vectors of the light.

26. The inspection method according to claim 19, wherein
the inspection condition include at least one of an illumination condition when illuminating the surface of the substrate with the polarized light, a detection condition when detecting the condition for prescribing the polarization state of the light, and a posture condition for the substrate to be illuminated with the polarized light.

27. The inspection method according to claim 26, wherein
the illumination condition include at least one of an incident angle of polarized light incident on the surface of the substrate, a wavelength of the polarized light incident on the surface of the substrate, and a polarization direction of the polarized light incident on the surface of the substrate.

28. The inspection method according to claim 26, wherein
the detection condition include at least one of a light receiving angle of light when detecting the light emitted from the surface of the substrate and a polarization direction of light when detecting the light emitted from the surface of the substrate.

29. The inspection method according to claim 26, wherein
the posture condition include at least one of an orientation of a repetitive direction of the pattern formed on the substrate illuminated with the polarized light, and an inclination angle of the substrate.

30. The inspection method according to claim 19, wherein
illuminating the surface of the substrate with polarized light is irradiating the surface of the substrate with linearly polarized light.

31. The inspection method according to claim 19, wherein
the detecting of the condition for prescribing the polarization state of the light includes receiving light specularly reflected from the surface of the substrate and detecting the condition for prescribing the polarization state of the light.

32. The inspection method according to claim 19, wherein
the inspection target pattern formed on the surface of the inspection target substrate is formed through a lithography process including exposure by an exposure device, and
a processing condition when determining the processing condition include at least one of an exposure amount and a focus state in the exposure device.

33. The inspection method according to claim 19, wherein
an entire surface of the substrate is illuminated when illuminating the surface of the substrate having the pattern formed on the surface thereof with polarized light, and
the entire surface of the substrate is imaged upon receiving light emitted from the surface of the substrate.

34. The inspection method according to claim 19, further comprising:
illuminating a part of the surface of the substrate when illuminating the surface of the substrate having the pattern formed on the surface thereof with polarized light;
imaging the part of the surface of the substrate upon receiving light emitted from the surface of the substrate; and
moving the substrate such that the entire surface of the substrate is sequentially irradiated with the polarized light.

35. An exposure method comprising:
exposing a surface of a substrate to a pattern;
determining the processing condition of the pattern using the inspection method described in claim 19; and
correcting a processing condition during exposure of the substrate according to the processing condition determined using the inspection method.

36. A device manufacturing method including a lithography process which provides a pattern on a surface of a substrate, the method using the exposure method described in claim 35 in the lithography process.
